(19) United States
(12) Patent Application Publication
(10) Pub. No.: US 2025/0260462 A1
(43) Pub. Date: Aug. 14, 2025

(54) ORTHOGONAL MULTIPLEXING OF SIGNALS FOR NON-COHERENT DETECTION OF WAKE-UP SEQUENCES

(71) Applicant: HUAWEI TECHNOLOGIES CO., LTD., Shenzhen (CN)

(72) Inventor: Fredrik BERGGREN, Kista (SE)

(21) Appl. No.: 19/190,371

(22) Filed: Apr. 25, 2025

Related U.S. Application Data
(63) Continuation of application No. PCT/EP2022/080303, filed on Oct. 28, 2022.

(51) Int. Cl. H04B 7/06; H04L 5/00; H04L 27/26; H04W 52/02

(52) U.S. Cl. CPC H04B 7/0634; H04L 5/0005; H04L 27/2636; H04W 52/0235

(57) ABSTRACT

Embodiments of the invention relate to multiplexing of signals in a communication system. A first communication device obtains a vector b comprising M number of integer valued information symbols from a set {0, 1, . . . , q−1}, where q=2^{Q} and where Q is a positive integer; and obtains a N×M matrix C comprising symbols from the set {0, 1, . . . , q−1}, where N is a positive integer such that M≤N. The matrix C is multiplied with the vector b modulo-q to obtain a vector y comprising N number of transmission symbols, wherein each transmission symbol in the vector y is associated with one of q number of signals. An associated signal is transmitted for each transmission symbol in the vector y to one or more receivers.

### CROSS-REFERENCE TO RELATED APPLICATIONS

This application is a continuation of International Application No. PCT/EP2022/080303, filed on Oct. 28, 2022, the disclosure of which is hereby incorporated by reference in its entirety.

### TECHNICAL FIELD

Embodiments of invention relate to a first communication device and a second communication device for multiplexing of signals in a communication system. Furthermore, embodiments of the invention also relate to corresponding methods and a computer program.

### BACKGROUND

A solution to reduce the power consumption in a user equipment (UE) is to put the UE in a sleep-mode and then use mechanisms that could provide wake up of the UE. In 3GPP long term evolution (LTE) and new radio (NR), this is primarily achieved by the discontinuous reception (DRX) feature, which makes the UE to wake up at configured periodic time instants to monitor the physical downlink control channel (PDCCH) in order to read the paging channel.

As an add-on to DRX, a wake-up signal (WUS) was defined in LTE, which is transmitted from the base station. Only if the UE detects the WUS, it will wake-up to monitor the PDCCH at the periodic time instants given by the DRX configuration, otherwise the UE can remain in sleep-mode. The WUS in LTE is based on orthogonal frequency division multiplexing (OFDM) waveform and it consists of a complex-valued sequence which the UE tries to detect.

### SUMMARY

An objective of embodiments of the invention is to provide a solution which mitigates or solves the drawbacks and problems of conventional solutions.

The above and further objectives are solved by the subject matter of the independent claims. Further embodiments of the invention can be found in the dependent claims.

According to a first aspect of the invention, the above mentioned and other objectives are achieved with a first communication device for a communication system, the first communication device being configured to:
obtain a vector b comprising M number of integer valued information symbols from a set {0, 1, . . . , q-1}, where q=2^{Q} and where Q is a positive integer;
obtain a N×M matrix C comprising symbols from the set {0, 1, . . . , q−1}, where N is a positive integer such that M≤N;
multiply the matrix C with the vector b modulo-q to obtain a vector y comprising N number of transmission symbols, wherein each transmission symbol in the vector y is associated with one of q number of signals; and
transmit an associated signal for each transmission symbol in the vector y to one or more receivers.

The first communication device may also be denoted a transmitter.

An advantage of the first communication device according to the first aspect is that information symbols for different receivers can be transmitted using signals that can be non-coherently detected by the receivers.

In an implementation form of a first communication device according to the first aspect, a component k with 1≤k≤N in the vector y is associated with time/frequency resource k.

An advantage with this implementation form is that signals such as frequency shift keying (FSK) or on-off keying (OOK) can be used for the transmission of the information symbols.

In an implementation form of a first communication device according to the first aspect, N=12n or N=14n for any positive integer value of n.

An advantage with this implementation form is that the transmission of the signals fit the time-frequency resource structure of 3GPP LTE and NR systems.

In an implementation form of a first communication device according to the first aspect, the vector b comprises information symbols for different receivers.

An advantage with this implementation form is that information symbols for different receivers can be transmitted on the same time-frequency resource.

In an implementation form of a first communication device according to the first aspect, the vector b comprises Sᵤ number of information symbols for receiver u such that

$${\sum }_{u = 1}^{U} {S}_{u} = M$$

where U is the number of receivers with 1≤U≤M.

An advantage with this implementation form is that transmission of multiple information symbols, to different receivers, could be transmitted on the same time-frequency resource.

In an implementation form of a first communication device according to the first aspect, the associated signal is any one of:
an on-off keying signal;
a frequency shift keying signal;
an orthogonal frequency division multiplex signal; or
a discrete Fourier transform precoded orthogonal frequency division multiplex signal.

An advantage with this implementation form is that low-complex receivers using non-coherent detection could be used.

In an implementation form of a first communication device according to the first aspect, at least one information symbol represents any one of:
an indicator to wake-up a receiver or a group of receivers;
an identity of a receiver or a group of receivers; or
a paging information associated with a receiver or a group of receivers.

An advantage with this implementation form is that the information represented by the information symbol can be used to achieve power saving in the receiver.

In an implementation form of a first communication device according to the first aspect, M=N, and wherein C and C⁻¹ comprise integer valued symbols from the set {0, 1, . . . , q−1} and fulfil

$${\sum }_{u = 1}^{U} {S}_{u} = M$$

where C⁻¹ is the modular inverse of C, I is the identity matrix and mod q is the modulo-q operator.

An advantage with this implementation form is that the information symbols can be perfectly retrieved by the receiver.

In an implementation form of a first communication device according to the first aspect, C is a N×N matrix and has a rank equal to N, where q=2, and wherein C⁻¹ fulfills at least one of:
C⁻¹ is a matrix with one element equal to 1 per row and per column;
C⁻¹ is a matrix where at least one row has an even Hamming weight;
C⁻¹ is a matrix where N−1 number of rows have an even Hamming weight;
C⁻¹ is a matrix where the rows have an odd Hamming weight;

C⁻¹ is a matrix with a total Hamming weight equal to N²−N+1 such that N−1 number of rows have a Hamming weight equal to N−1 and 1 row has a Hamming weight equal to N; and/or

C⁻¹ is a matrix where every row has the same odd-valued Hamming weight.

The Hamming weight w(x) of a matrix or vector x is defined as the number of positive elements in x.

An advantage with this implementation form is that C can be constructed such that the probability of erroneously detecting the information symbols is minimized.

In an implementation form of a first communication device according to the first aspect, C is a N×N matrix and has rank equal to N, where Q>1, and wherein C is any row or column permuted version of a matrix C̅ given as

$$\overline{C} = ( \begin{matrix}{c}_{11} & 0 & 0 & 0 \\ 0 & {c}_{22} & 0 & 0 \\ ⋮ & ⋮ & ⋱ & ⋮ \\ 0 & 0 & 0 & {c}_{NN}\end{matrix} )$$

where cu are odd integers from the set {0, 1, . . . , q−1}, and where for at least one i with 1≤i≤N, each symbol in the set {0, 1, . . . , q−1} is associated with a bit label such that a difference in Hamming weight between bit labels for symbol X and Y=cᵢᵢ⁻¹ X(mod q) is at most 1.

The rank of a matrix C may be defined as the maximal number of linearly independent columns of C.

An advantage with this implementation form is that q=2^{Q}>2 bits can be processed simultaneously, which can reduce the implementation complexity in the transmitter and the receiver.

In an implementation form of a first communication device according to the first aspect, M=N, wherein t is the smallest positive integer such that C^{t}=I (mod q), and wherein up to t−1 matrices are generated for the communication system (500) as:
{C, C², . . . , c^{t-1}}.

An advantage with this implementation form is that different multiplexing matrices could be used in the communication system, e.g., using different matrices in different cells, and the different matrices could be obtained from C.

In an implementation form of a first communication device according to the first aspect, C is a N×M matrix and has a rank equal to M, where M<N and q=2, and wherein C fulfills at least one of:
C is obtained from any row or column permutation of a matrix \tilde{C} given as

$$\tilde{C} = [ \begin{matrix}P \\ A\end{matrix} ]$$

where P is an M×M matrix with distinct rows and columns and where every row and every column contains one non-zero element, and where A is an (N−M)×M matrix; a product of C′C has a rank equal to M where C′ is the transpose of C; and/or C comprises orthogonal column vectors with an odd Hamming weight.

An advantage with this implementation form is that the probability of signal detection can be increased, since N signals are used to transmit M information symbols, with M<N.

According to a second aspect of the invention, the above mentioned and other objectives are achieved with a second communication device for a communication system, the second communication device being configured to:
receive N number of signals, wherein each signal is associated with a symbol from a set {0, 1, . . . , q−1}, where q=2^{Q} and where Q is a positive integer;

determine M number of integer valued information symbols from N number of associated symbols based on a N×M matrix C or its modular inverse, where the matrix C and its modular inverse comprises symbols from the set {0, 1, . . . , q−1}, where N is a positive integer such that M≤N.

The second communication device may also be denoted a receiver.

An advantage of the second communication device according to the second aspect is that information symbols can be transmitted from a transmitter using signals that can be non-coherently detected by the second communication device.

In an implementation form of a second communication device according to the second aspect, a signal is any one of:
an on-off keying signal;
a frequency shift keying signal;
an orthogonal frequency division multiplex signal; or
a discrete Fourier transform precoded orthogonal frequency division multiplex signal.

An advantage with this implementation form is that the second communication device can use a low-complex receiver for non-coherent detection.

In an implementation form of a second communication device according to the second aspect, at least one information symbol represents any one of:

an indicator to wake-up a receiver or a group of receivers; an identity of a receiver or a group of receivers; or a paging information associated with a receiver or a group of receivers.

An advantage with this implementation form is that the information represented by the information symbol can be used to achieve power saving in the second communication device.

In an implementation form of a second communication device according to the second aspect, M=N, and wherein C and C⁻¹ comprise integer valued symbols from the set {0, 1, . . . , q−1} and fulfil

$${C}^{- 1} C = I ( mod q ) ,$$

where C⁻¹ is the modular inverse of C, I is the identity matrix and mod q is the modulo-q operator.

An advantage with this implementation form is that the information symbols can be perfectly retrieved by the second communication device.

In an implementation form of a second communication device according to the second aspect, C is a N×N matrix and has a rank equal to N, where q=2, and wherein C⁻¹ fulfills at least one of:
C⁻¹ is a matrix with one element equal to 1 per row and per column;
C⁻¹ is a matrix where at least one row has an even Hamming weight;
C⁻¹ is a matrix where N−1 number of rows have an even Hamming weight;
C⁻¹ is a matrix where the rows have an odd Hamming weight;
C⁻¹ is a matrix with a total Hamming weight equal to N²−N+1 such that N−1 number of rows have a Hamming weight equal to N−1 and 1 row has a Hamming weight equal to N; and/or
C⁻¹ is a matrix where every row has the same odd-valued Hamming weight.

An advantage with this implementation form is that C can be constructed such that the probability of erroneously detecting the information symbols is minimized.

In an implementation form of a second communication device according to the second aspect, C is a N×N matrix and has rank equal to N, where Q>1, and wherein C is any row or column permuted version of a matrix C̅ given as

$$\overline{C} = ( \begin{matrix}{c}_{11} & 0 & 0 & 0 \\ 0 & {c}_{22} & 0 & 0 \\ ⋮ & ⋮ & ⋱ & ⋮ \\ 0 & 0 & 0 & {c}_{NN}\end{matrix} )$$

where cᵢᵢ are odd integers from the set {0, 1, . . . , q−1}, and where for at least one i with 1≤i≥N, each symbol in the set {0, 1, . . . , q−1} is associated with a bit label such that a difference in Hamming weight between bit labels for symbol X and Y=cᵢᵢ⁻¹ X(mod q) is at most 1.

An advantage with this implementation form is that q=2^{Q}>2 bits can be processed simultaneously, which can reduce the implementation complexity in the transmitter and the receiver.

In an implementation form of a second communication device according to the second aspect, C is a N×M matrix and has a rank equal to M, where M<N and q=2, and wherein C fulfills at least one of:
C is obtained from any row or column permutation of a matrix \tilde{C} given as

$$\tilde{C} = [ \begin{matrix}P \\ A\end{matrix} ]$$

where P is an M×M matrix with distinct rows and columns and where every row and every column contains one non-zero element, and where A is an (N−M)×M matrix; a product of C′C has a rank equal to M where C′ is the transpose of C; and/or C comprises orthogonal column vectors with an odd Hamming weight.

An advantage with this implementation form is that the probability of signal detection can be increased, since N signals are used to transmit M information symbols, with M<N.

According to a third aspect of the invention, the above mentioned and other objectives are achieved with a method for a first communication device, the method comprises
obtaining a vector b comprising M number of integer valued information symbols from a set {0, 1, . . . , q−1}, where q=2^{Q} and where Q is a positive integer;
obtaining a N×M matrix C comprising symbols from the set {0, 1, . . . , q−1}, where N is a positive integer such that M≤N;
multiplying the matrix C with the vector b modulo-q to obtain a vector y comprising N number of transmission symbols, wherein each transmission symbol in the vector y is associated with one of q number of signals; and
transmitting an associated signal for each transmission symbol in the vector y to one or more receivers.

The method according to the third aspect can be extended into implementation forms corresponding to the implementation forms of the first communication device according to the first aspect. Hence, an implementation form of the method comprises the feature(s) of the corresponding implementation form of the first communication device.

The advantages of the methods according to the third aspect are the same as those for the corresponding implementation forms of the first communication device according to the first aspect.

According to a fourth aspect of the invention, the above mentioned and other objectives are achieved with a method for a second communication device, the method comprises
receiving N number of signals, wherein each signal is associated with a symbol from a set {0, 1, . . . , q−1}, where q=2^{Q} and where Q is a positive integer;

determining M number of integer valued information symbols from N number of associated symbols based on a N×M matrix C or its modular inverse, where the matrix C and its modular inverse comprises symbols from the set {0, 1, . . . , q−1}, where N is a positive integer such that M≤N.

The method according to the fourth aspect can be extended into implementation forms corresponding to the implementation forms of the second communication device according to the second aspect. Hence, an implementation form of the method comprises the feature(s) of the corresponding implementation form of the second communication device.

The advantages of the methods according to the fourth aspect are the same as those for the corresponding implementation forms of the second communication device according to the second aspect.

Embodiments of the invention also relate to a computer program, characterized in program code, which when run by at least one processor causes the at least one processor to execute any method according to embodiments of the invention. Further, embodiments of the invention also relate to a computer program product comprising a computer readable medium and the mentioned computer program, wherein the computer program is included in the computer readable medium, and may comprises one or more from the group of: read-only memory (ROM), programmable ROM (PROM), erasable PROM (EPROM), flash memory, electrically erasable PROM (EEPROM), hard disk drive, etc.

Further applications and advantages of embodiments of the invention will be apparent from the following detailed description.

### BRIEF DESCRIPTION OF THE DRAWINGS

The appended drawings are intended to clarify and explain different embodiments of the invention, in which:

FIG. 1 shows a first communication device according to an embodiment of the

invention;

FIG. 2 shows a flow chart of a method for a first communication device according to an embodiment of the invention;

FIG. 3 shows a second communication device according to an embodiment of the invention;

FIG. 4 shows a flow chart of a method for a second communication device according to an embodiment of the invention;

FIG. 5 shows a communication system according to an embodiment of the invention; and

FIG. 6 shows a block diagram of a transmitter according to an embodiment of the invention;

FIG. 7 shows a block diagram of a receiver according to an embodiment of the invention;

FIG. 8 shows bit error probability for a Gilbert-Elliot channel using the C matrix of (51) and the Hamming code of (46);

FIG. 9 shows bit error probability for a Gilbert-Elliot channel using the C matrix of (51) and the Hamming code of (46);

FIG. 10 shows comparison of bit error probability for a Gilbert-Elliot channel using different demultiplexing algorithms;

FIG. 11 shows a block diagram of transmitter and receiver with q-ary signaling;

FIG. 12 shows BER as function of BSC error probability when the input symbols are zero; and

FIG. 13 shows bit error rate as function of the BSC error probability for optimized, natural and Gray mapping.

### DESCRIPTION OF EMBODIMENTS

In contrast to the OFDM based WUS in LTE, it would be possible to design a sophisticated WUS by using a separate radio unit for the WUS, with a specific waveform which is highly optimized for low complexity detection and low power consumption. This includes waveforms that can be non-coherently detected (i.e., by energy detection), e.g., frequency shift keying (FSK), pulse position modulation (PPM) and on-off keying (OOK). However, if energy detection is performed in the receiver, the phase of the signal cannot be detected. Therefore, it is not possible to transmit a bi-phase or complex-valued sequence on the WUS.

If a different waveform is used for the WUS, the time-frequency resources for the WUS have to be separate from the other signals/channels in the system, which makes it important to use as few resources as possible for the WUSs. For the WUS in LTE, since it is coherently detected, the complex-valued sequences can be constructed to be orthogonal, which makes it possible to multiplex WUSs of different UEs on the same time-frequency resource. Thus, multiplexing is performed by superposition of the respective WUSs. However, with non-coherent detection such as energy detection, the receiver output is typically binary, i.e., indicating whether the WUS is received or not, which makes it an open issue of how to multiplex WUSs.

No dedicated radio unit is assumed for the LTE WUS and the UE can maintain time-frequency synchronization such that it can coherently detect the sequence. In LTE Rel-15, the WUS addresses all the UEs configured with specific time slots where they monitor the paging channel. This implies that a UE may receive the WUS although it is intended for another UE, which causes an unnecessary wake-up. In LTE Rel-16, this problem was mitigated and a finer resolution was introduced through the concept of group WUS, for which UEs can be configured into groups of UEs. The sequences for different groups can be orthogonal, and thus WUSs can be multiplexed. Up to 8 groups can be configured.

In general, the spectrum efficiency is improved if multiplexing of WUSs can be made on shared time-frequency resources. Since the number of transmitted WUSs will vary over time, shared resources offer statistical multiplexing gain. On the other hand, with dedicated orthogonal resources, e.g., by frequency division multiplexing (FDM) or time division multiplexing (TDM), more resources may need to be allocated for the WUS and, moreover, the spectrum usage on each dedicated resource is on average smaller.

Thus, an objective of embodiments of the invention is to increase the spectral efficiency of a communication system, especially for waveforms which are non-coherently detected, by multiplexing such signals, e.g., the WUSs transmitted from the base station to different UEs, on the same time-frequency resource. Waveforms that are non-coherently detected typically only have a finite set of transmit states, e.g., one signal representing ‘0’ and one signal representing ‘1’. Multiplexing with non-coherent detection receivers can therefore not use orthogonal sequences complex-valued sequences, as was assumed in the LTE WUS. Moreover, superposition of signals generates a signal different from any of the original signals, e.g., the signals representing a ‘0’ or ‘1’. Embodiments of the invention solves the problem of multiplexing WUSs and other types of signals, wherein the transmitted waveform of the multiplexed signals is the same as the waveforms of the respective signal. That is, the multiplexing is done such there is no direct superposition of the respective signals for the different multiplexed signals.

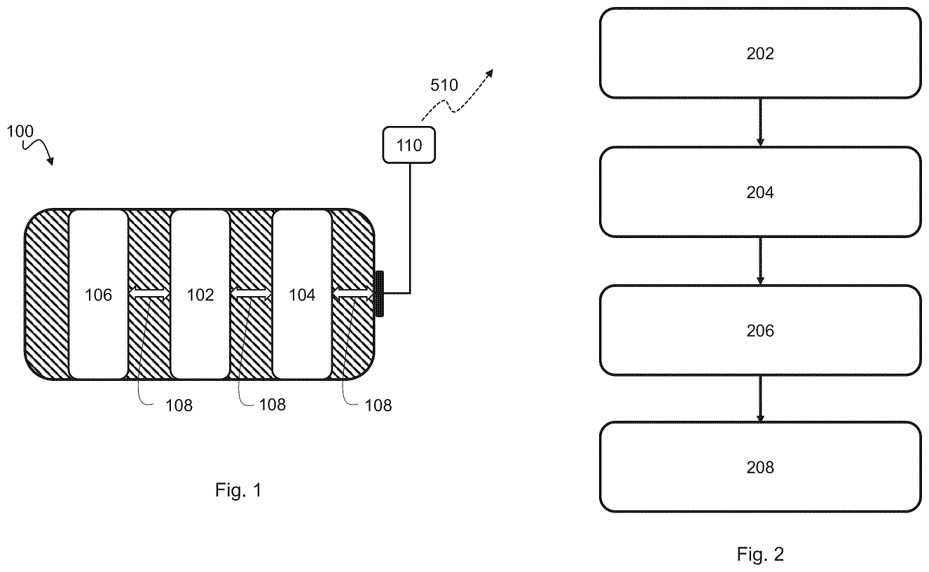

FIG. 1 shows a first communication device 100 according to an embodiment of the invention. In the embodiment shown in FIG. 1, the first communication device 100 comprises a processor 102, a transceiver 104 and a memory 106. The processor 102 is coupled to the transceiver 104 and the memory 106 by communication means 108 known in the art. The first communication device 100 may be configured for wireless and/or wired communications in a communication system. The wireless communication capability may be provided with an antenna or antenna array 110 coupled to the transceiver 104.

The processor 102 may be referred to as one or more general-purpose central processing units (CPUs), one or more digital signal processors (DSPs), one or more application-specific integrated circuits (ASICs), one or more field programmable gate arrays (FPGAs), one or more programmable logic devices, one or more discrete gates, one or more transistor logic devices, one or more discrete hardware components, or one or more chipsets. The memory 106 may be a read-only memory, a random access memory (RAM), or a non-volatile RAM (NVRAM). The transceiver 304 may be a transceiver circuit, a power controller, or an interface providing capability to communicate with other communication modules or communication devices, such as network nodes and network servers. The transceiver 104, memory 106 and/or processor 102 may be implemented in separate chipsets or may be implemented in a common chipset.

That the first communication device 100 is configured to perform certain actions can in this disclosure be understood to mean that the first communication device 100 comprises suitable means, such as e.g., the processor 102 and the transceiver 104, configured to perform the actions.

According to embodiments of the invention the first communication device 100 is configured to obtain a vector b comprising M number of integer valued information symbols from a set {0, 1, . . . , q−1}, where q=2^{Q} and where Q is a positive integer. The first communication device 100 is configured to obtain a N×M matrix C comprising symbols from the set {0, 1, . . . , q−1}, where N is a positive integer such that M≤N. The first communication device 100 is configured to multiply the matrix C with the vector b modulo-q to obtain a vector y comprising N number of transmission symbols, wherein each transmission symbol in the vector y is associated with one of q number of signals. The first communication device 100 is configured to transmit an associated signal 510 for each transmission symbol in the vector y to one or more receivers.

The information symbols may e.g., represent information needed for a receiver to wake-up. The information symbols may additionally be obtained from the output of a forward error correcting code (FEC) encoder. The first communication device 100 can arrange the information symbols into the vector b. Further, the matrix C may be predefined according to a communication standard or be determined from a set of matrices which may be defined by a communication standard.

Furthermore, in an embodiment of the invention, the first communication device 100 comprises a processor configured to: obtain a vector b comprising M number of integer valued information symbols from a set {0, 1, . . . , q−1}, where q=2^{Q} and where Q is a positive integer; obtain a N×M matrix C comprising symbols from the set {0, 1, . . . , q−1}, where N is a positive integer such that M≤N; and multiply the matrix C with the vector b modulo-q to obtain a vector y comprising N number of transmission symbols, wherein each transmission symbol in the vector y is associated with one of q number of signals. The first communication device 100 comprises a transceiver configured to transmit an associated signal 510 for each transmission symbol in the vector y to one or more receivers.

Moreover, in yet another embodiment of the invention, the first communication 100 for a communication system 500 comprises a processor and a memory having computer readable instructions stored thereon which, when executed by the processor, cause the processor to: obtain a vector b comprising M number of integer valued information symbols from a set {0, 1, . . . , q−1}, where q=2^{Q} and where Q is a positive integer; obtain a N×M matrix C comprising symbols from the set {0, 1, . . . , q−1}, where N is a positive integer such that M≤N; multiply the matrix C with the vector b modulo-q to obtain a vector y comprising N number of transmission symbols, wherein each transmission symbol in the vector y is associated with one of q number of signals; and transmit an associated signal 510 for each transmission symbol in the vector y to one or more receivers.

FIG. 2 shows a flow chart of a corresponding method 200 which may be executed in a first communication device 100, such as the one shown in FIG. 1. The method 200 comprises obtaining 202 a vector b comprising M number of integer valued information symbols from a set {0, 1, . . . , q−1}, where q=2^{Q} and where Q is a positive integer. The method 200 comprises obtaining 204 a N×M matrix C comprising symbols from the set {0, 1, . . . , q−1}, where N is a positive integer such that M≤N. The method 200 comprises multiplying 206 the matrix C with the vector b modulo-q to obtain a vector y comprising N number of transmission symbols, wherein each transmission symbol in the vector y is associated with one of q number of signals. The method 200 comprises transmitting 208 an associated signal 510 for each transmission symbol in the vector y to one or more receivers.

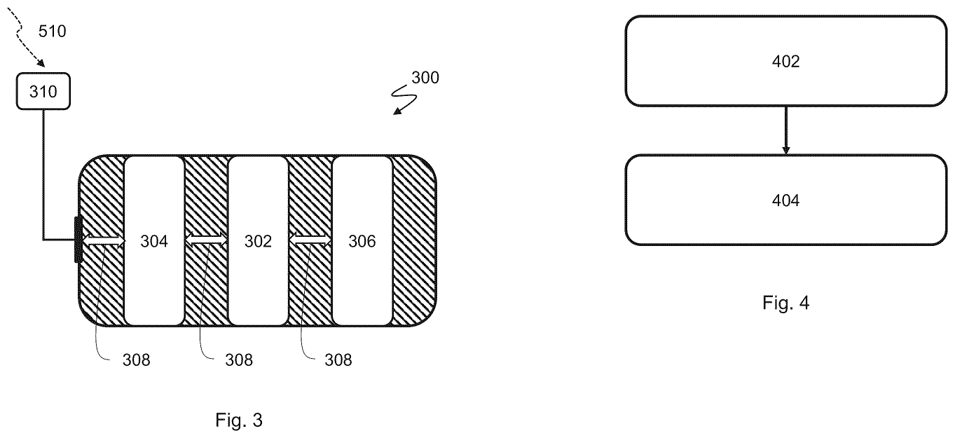

FIG. 3 shows a second communication device 300 according to an embodiment of the invention. In the embodiment shown in FIG. 3, the second communication device 300 comprises a processor 302, a transceiver 304 and a memory 306. The processor 302 is coupled to the transceiver 304 and the memory 306 by communication means 308 known in the art. The second communication device 300 further comprises an antenna or antenna array 310 coupled to the transceiver 304, which means that the second communication device 300 is configured for wireless communications in a communication system.

The processor 302 may be referred to as one or more general-purpose CPUs, one or more DSPs, one or more ASICs, one or more FPGAs, one or more programmable logic devices, one or more discrete gates, one or more transistor logic devices, one or more discrete hardware components, one or more chipsets. The memory 306 may be a read-only memory, a RAM, or a NVRAM. The transceiver 104 may be a transceiver circuit, a power controller, or an interface providing capability to communicate with other communication modules or communication devices. The transceiver 304, the memory 306 and/or the processor 302 may be implemented in separate chipsets or may be implemented in a common chipset.

That the second communication device 300 is configured to perform certain actions can in this disclosure be understood to mean that the second communication device 300 comprises suitable means, such as e.g., the processor 302 and the transceiver 304, configured to perform the actions.

According to embodiments of the invention the second communication device 300 is configured to receive N number of signals 510, wherein each signal is associated with a symbol from a set {0, 1, . . . , q−1}, where q=2^{Q} and where Q is a positive integer. The second communication device 300 is configured to determine M number of integer valued information symbols from N number of associated symbols based on a N×M matrix C or its modular inverse, where the matrix C and its modular inverse comprises symbols from the set {0, 1, . . . , q−1}, where N is a positive integer such that M≤N.

Furthermore, in an embodiment of the invention, the second communication device 300 comprises a transceiver configured to: receive N number of signals 510, wherein each signal is associated with a symbol from a set {0, 1, . . . , q−1}, where q=2^{Q} and where Q is a positive integer. The second communication device 300 comprises a processor configured to determine M number of integer valued information symbols from N number of associated symbols based on a N×M matrix C or its modular inverse, where the matrix C and its modular inverse comprises symbols from the set {0, 1, . . . , q−1}, where N is a positive integer such that M≤N.

Moreover, in yet another embodiment of the invention, the second communication device 300 comprises a processor and a memory having computer readable instructions stored thereon which, when executed by the processor, cause the processor to: receive N number of signals 510, wherein each signal is associated with a symbol from a set {0, 1, . . . , q−1}, where q=2^{Q} and where Q is a positive integer; and determine M number of integer valued information symbols from N number of associated symbols based on a N×M matrix C or its modular inverse, where the matrix C and its modular inverse comprises symbols from the set {0, 1, . . . , q−1}, where N is a positive integer such that M≤N.

FIG. 4 shows a flow chart of a corresponding method 400 which may be executed in a second communication device 300, such as the one shown in FIG. 3. The method 400 comprises receiving 402 N number of signals 510, wherein each signal is associated with a symbol from a set {0, 1, . . . , q−1}, where q=2^{Q} and where Q is a positive integer. The method 400 comprises determining 404 M number of integer valued information symbols from N number of associated symbols based on a N×M matrix C or its modular inverse, where the matrix C and its modular inverse comprises symbols from the set {0, 1, . . . , q−1}, where N is a positive integer such that M≤N.

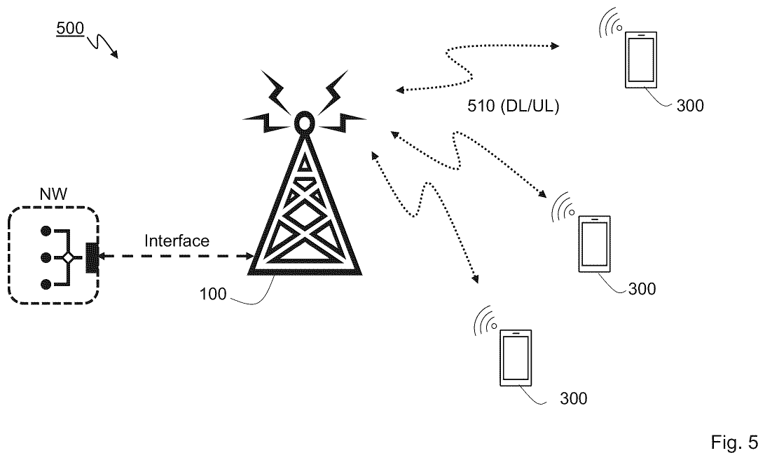

FIG. 5 shows a communication system 500 according to an embodiment of the invention. The communication system 500 in the disclosed embodiment comprises a first communication device 100 and one or more second communication devices 300 configured to communicate and operate in the communication system 500. The first communication device 100 may be denoted a transmitter device or simply a transmitter, and the second communication device 300 may be denoted a receiver device or simply a receiver or sometimes also a user. The first communication device 100 may however also have receiving capabilities and the second communication devices may have transmitting capabilities. In the non-limiting example shown in FIG. 5, the first communication device 100 act as a network access node such as a gNB in communication with one or more second communication devices 300 acting as client devices such as UEs. The network access node may be connected to a network (NW) of the communication system such as a core network via a communication interface. However, it may be noted that the reverse case is also possible, i.e., the first communication device 100 is a client device and the second communication device 300 is a network access node. The communication between the first communication device 100 and the second communication devices 300 may be performed in the downlink (DL) and in the uplink (UL) when the communication system is a 3GPP LTE or NR system.

As aforementioned, the vector b comprises M number of integer valued information symbols from a set {0, 1, . . . , q−1}, where q=2^{Q} and where Q is a positive integer. Vector b may be expressed as

$$b = {( {b}_{1} , {b}_{2} , … , {b}_{M} )}^{′} \qquad ( 1 )$$

where (.)′ denotes the transpose and symbol bᵢ in vector b denotes which of the q signals that should be transmitted from the transmitter to the receiver i or to a group of receivers i.

Multiplexing codes for 1≤i≤M, with M≤N, are given by the vectors with symbols:

$${c}^{( i )} = {( {c}_{1}^{( i )} , {c}_{2}^{( i )} , … , {c}_{N}^{( i )} )}^{′} \qquad ( 2 )$$

An N×M with M≤N multiplexing code matrix C where the columns contain the multiplexing codes:

$$C = [ {c}^{( 1 )} , {c}^{( 2 )} , … , {c}^{( M )} ] \qquad ( 3 )$$

The rank of C is equal to M, where the rank is determined assuming addition of vectors is performed modulo q.

The integer valued information symbols in vector b are multiplexed with the multiplexing code matrix C so as to generate the transmission symbols y by the N×1 vector

$$y = Cb ( mod q ) \qquad ( 4 )$$

where(mod q) is the modulo-q operator. Thus, a multiplexing scheme is herein disclosed.

In embodiments of the invention, M=N for the multiplexing code matrix C, and where t is the smallest positive integer such that Ct=I(mod q), up to t−1 matrices may be generated for the communication system 500 according to:

$$\{ C , {C}^{2} , … , {C}^{t - 1} \} \qquad ( 5 )$$

Thus, up to t−1 orthogonal sets of multiplexing codes may be generated. Each set of orthogonal sets may be used in different cells of a cellular system but is not limited thereto.

Moreover, when the vector b comprises information symbols for different receivers or users, the vector b in embodiments of the invention may comprise Sᵤ number of information symbols for a receiver u such that

$${\sum }_{u = 1}^{U} {S}_{u} = M \qquad ( 6 )$$

where U is the number of receivers with 1≤U≤M, and where

$$b = {( {b}_{11} , {b}_{12} , … , {b}_{1 {S}_{1}} , {b}_{21} , {b}_{22} , … , {b}_{2 {S}_{2}} , … , {b}_{U 1} , {b}_{U 2} , … , {b}_{{US}_{U}} )}^{′} . \qquad ( 7 )$$

Depending on whether N=M or N>M for the matrix C different conditions may apply according to embodiments of the invention. Some of these conditions are summarized below and will be described more in detail in the following disclosure.

In embodiments of the invention, when M=N for the multiplexing code matrix C, and where C and C⁻¹ comprise integer valued symbols from the set {0, 1, . . . , q−1} the following condition is fulfilled

$${C}^{- 1} C = I ( mod q ) ,$$

where C⁻¹ is the modular inverse of C, I is the identity matrix and mod q is the modulo-q operator.

In embodiments of the invention, when the multiplexing code matrix C is a N×N matrix and has a rank equal to N, where q=2, the modular inverse C⁻¹ fulfills at least one of:
C⁻¹ is a matrix with one element equal to 1 per row and per column;
C⁻¹ is a matrix where at least one row has an even Hamming weight;
C⁻¹ is a matrix where N−1 number of rows have an even Hamming weight;
C⁻¹ is a matrix where the rows have an odd Hamming weight;
C⁻¹ is a matrix with a total Hamming weight equal to N²−N+1 such that N−1 number of rows have a Hamming weight equal to N−1 and 1 row has a Hamming weight equal to N; and/or
C⁻¹ is a matrix where every row has the same odd-valued Hamming weight.

In embodiments of the invention, when the multiplexing code matrix C is a N×N matrix and has rank equal to N, where Q>1, the multiplexing code matrix C is any row or column permuted version of a matrix C̅ given as

$$\overline{C} = ( \begin{matrix}{c}_{11} & 0 & 0 & 0 \\ 0 & {c}_{22} & 0 & 0 \\ ⋮ & ⋮ & ⋱ & ⋮ \\ 0 & 0 & 0 & {c}_{NN}\end{matrix} )$$

where cᵢᵢ are odd integers from the set {0, 1, . . . , q−1}, and where for at least one i with 1≤i≤N, each symbol in the set {0, 1, . . . , q−1} is associated with a bit label such that a difference in Hamming weight between bit labels for symbol X and Y=cᵢᵢ⁻¹ X(mod q) is at most 1.

In embodiments of the invention, when the multiplexing code matrix C is a N×M matrix and has a rank equal to M, where M<N and q=2, the multiplexing code matrix C fulfills at least one of:
C is obtained from any row or column permutation of a matrix \tilde{C} given as

$$\tilde{C} = [ \begin{matrix}P \\ A\end{matrix} ]$$

where P is an M×M matrix with distinct rows and columns and where every row and every column contains one non-zero element, and where A is an (N−M)×M matrix;
a product of C′C has a rank equal to M where C′ is the transpose of C; and/or
C comprises orthogonal column vectors with an odd Hamming weight.

Moreover, further embodiments of the invention relate to signal aspects, time-frequency resources used for the transmission of the multiplexed signals, and the application of the multiplexed signals in different implementations and scenarios.

Thus, in embodiments of the invention, the associated signal 510 is any one of:
An on-off keying signal;
A frequency shift keying signal;
An orthogonal frequency division multiplex signal; or
A discrete Fourier transform precoded orthogonal frequency division multiplex signal.

For the transmission of the associated signal 510, the first communication device 100 may transmit the associated signal 510 corresponding to symbol yₖ on time-frequency resource k. In other words, a component k with 1≤k≤N in the vector y is associated with time/frequency resource k. A time-frequency resource may denote, e.g., a time slot, an OFDM symbol, a subcarrier, a set of subcarriers, wherein a signal can be transmitted. Further, N=12n or N=14n for any positive integer value of n.

Further, in embodiments of the invention, the associated signal 510 may be used in many different applications and this means that at least one information symbol represents any one of:

An indicator to wake-up a receiver or a group of receivers;

An identity of a receiver or a group of receivers; or

A paging information associated with a receiver or a group of receivers.

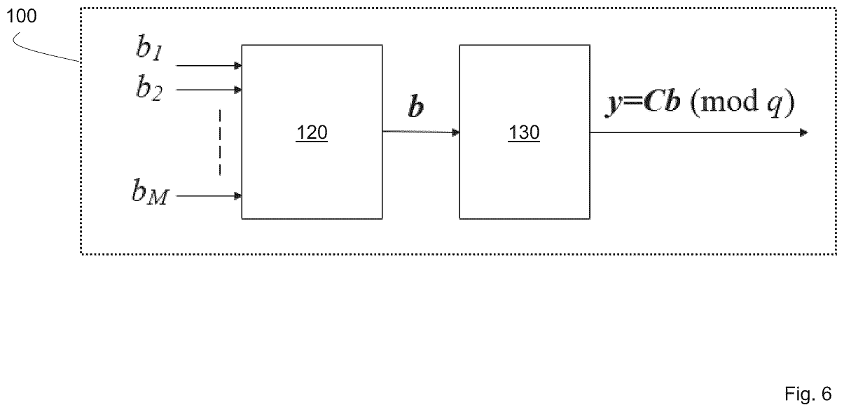

FIG. 6 shows a block diagram of a part of the first communication device 100 acting as a transmitter according to embodiment of the invention. The block diagram shows a vectorization block 120 connected to a multiplexing block 130.

Consider a set of symbols comprising q symbols {0,1, . . . , q−1}, wherein q=2^{Q} where Q is a positive integer, and an associated N-dimensional vector space F_{q}^{N}. Addition and multiplication are performed modulo q. Suppose symbols representing signals for M different receivers are received and arranged in a vector b by a vectorization block 120, where the symbols are given by the vector,

$$b = {( {b}_{1} , {b}_{2} , … , {b}_{M} )}^{′} \qquad ( 8 )$$

where (.)′ denotes transpose. The symbol b; represents which of the q associated signals 510 that is to be transmitted from the transmitter to the receiver i. The receiver i could be a single user or denote a group of users. Define multiplexing codes for 1≤i≤M, with M≤N, given by the vector:

$${c}^{( i )} = {( {c}_{1}^{( i )} , {c}_{2}^{( i )} , … , {c}_{N}^{( i )} )}^{′} \qquad ( 9 )$$

The condition M≤N implies that orthogonal multiplexing is possible, i.e., vector b can be perfectly detected. Furthermore, define an N×M multiplexing code matrix where the columns contain the multiplexing codes:

$$C = [ {c}^{( 1 )} , {c}^{( 2 )} , … , {c}^{( M )} ] \qquad ( 10 )$$

The transmitter is multiplexing the symbols in the multiplexing block 130 by generating linear combinations of the components in the vector b and is generating transmission symbols as output by the N×1 vector

$$y = Cb ( mod q ) \qquad ( 11 )$$

where(mod q) denotes the modulo-q operator. Hence, the values in y are from the set {0, 1, . . . , q−1}. Thus, q signals could be used to multiplex the M information symbols.

The components in y may correspond to time/frequency resources, e.g., N time slots or frequencies, wherein each time slot or frequency k one of q signals (FSK frequency, PPM pulse etc.) is transmitted, which is determined by the entry yₖ. Hence, according to (11), multiplexing is made in the symbol domain by using the q signals and there is no superposition of any of the q signals.

The vector b could as previously described be generalized to represent the transmission of S number of symbols to U receivers, i.e., users or group of users, where M=SU and 1≤U≤M, such that:

$$b = {( {b}_{11} , {b}_{12} , … , {b}_{1 S} , {b}_{21} , {b}_{22} , … , {b}_{2 S} , … , {b}_{U 1} , {b}_{U 2} , … , {b}_{US} )}^{′} \qquad ( 12 )$$

In that case, the signals deliver information corresponding to S·log₂ q bits to each receiver. A further generalization is where Sᵤ symbols are transmitted to user u, with

$${\sum }_{u = 1}^{U} {S}_{u} = M \qquad ( 13 )$$

$$and$$

$$b = {( {b}_{11} , {b}_{12} , … , {b}_{1 {S}_{1}} , {b}_{21} , {b}_{22} , … , {b}_{2 {S}_{2}} , … , {b}_{U 1} , {b}_{U 2} , … , {b}_{{US}_{U}} )}^{′} . \qquad ( 14 )$$

An information symbol could denote an indicator to wake-up a receiver, or a group of receivers. For example, if U=M and q=2, information symbol bᵢ could indicate whether receiver i, or receivers in group i, should wake-up. Furthermore, in a cellular network, the receivers (i.e., UEs) are assigned network identifiers, e.g., a Radio Network Temporary Identifier (RNTI). The information symbols could therefore denote an identity of a receiver or a group of receivers. If the detected identity is the same as that of the receiver, or the group of receivers, these receivers should wake-up. Moreover, the information symbols could relate to information related to the monitoring of the paging channel for a receiver, or a group of receivers. Such information may comprise paging occasions or other information needed to receive the paging channel.

An objective of the invention is thus to construct C such that the error probability for detecting b is minimized, assuming that the receivers know C. For example, in a NR WUS scenario if q=2, misdetecting a ‘0’ to be a ‘1’ means that the UE will do an unnecessary wake-up, while misdetecting a ‘1’ to be a ‘0’ means that the UE will not wake-up when it is supposed to.

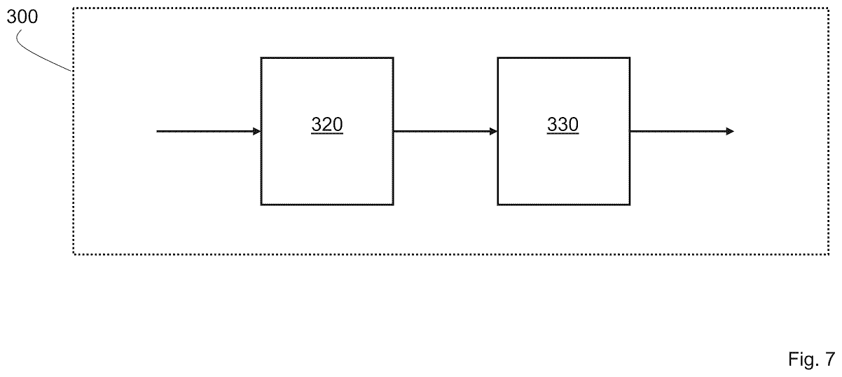

FIG. 7 shows a block diagram of a part of the second communication device 300 acting as a receiver according to embodiments of the invention. The block diagram shows a signal detector 320 connected to a demultiplexing block 330. The signal detector 320 is configured to receive radio signals and produces N outputs feed to the demultiplexing block 330, wherein each output denotes which of the q signals that were detected. The signal detector 320 may comprise non-coherent detection in embodiments of the invention. The demultiplexing block 330 is configured to detect the information symbols that were transmitted for the receiver.

For the case M=N, well-known matrix properties imply the following equivalent statements:

The rank of C is N.

There exists an inverse C⁻¹ such that C⁻¹C=CC⁻¹=I, where I is the identity matrix.

The rank of C⁻¹ is N.

There exists a unique solution to y=Cb which is given by b=C⁻¹y.

These properties also hold when the matrix elements are constrained to be from the set of q symbols, with the caveat that the computations should be made modulo-q and the matrix C⁻¹ is referred to as the modular matrix inverse. When computing the rank, all arithmetic operations should be carried out modulo q. Hence, condition (i.) is equivalent to that
Condition 1: If C is an N×N matrix, it should have rank equal to N over F.
   the columns (or rows) of C are linearly independent in F_{q}^{N}. To have orthogonal multiplexing we will thus require that:

Consider to transmit the associated signals 510 corresponding to transmission symbols in vector y over a channel and denote the received vector r=(r₁, r₂, . . . , R_{N})′ with rᵢ∈{0,1, . . . , q−1} and the error vector e=(e₁, e₂, . . . , e_{N})′ with eᵢ∈{0,1, . . . , q−1}, such that

$$r = Cb + e ( mod q ) \qquad ( 15 )$$

from which demultiplexing can be linearly performed as:

$$\begin{matrix}\hat{b} = {C}^{- 1} r ( mod q ) \\ = b + {C}^{- 1} e ( mod q )\end{matrix} \qquad ( 16 )$$

For example, r could be the output of a non-coherent detector and if q=2, its components are ‘0’ or ‘l’ representing whether the energy of the WUS was above a pre-defined detection threshold, set to achieve a certain false alarm rate. The matrix C can be assumed to be known by all receivers and the ith receiver or a receiver in the ith group of receivers extracts the ith element of \hat{b}. To extract the ith element of \hat{b}, r is multiplied with the ith row of C⁻¹. Thus, in one example, the ith receiver only needs to perform the multiplication with the ith row of C⁻¹.

Constructions of Multiplexing Codes when N=M

From mathematical group theory, the general linear group of degree N is defined as the set of N×N invertible matrices, which over the set of symbols {0,1, . . . , q−1} is denoted by GL(N, q). The order of GL(N, q), i.e., the number of matrices in the group, has been shown to be given by

$${O}_{N , q} = {\prod }_{k = 0}^{N - 1} ( {q}^{N} - {q}^{k} ) \qquad ( 17 )$$

and the order of an element of the group, i.e., a matrix C, has order t if it is the minimum integer that fulfills:

$${C}^{t} = I \qquad ( 18 )$$

It is further known that all elements of finite groups have finite order t and that t is a divisor of O_{N,q}. The order t can be determined by finding the minimum polynomial of the matrix C, i.e., the lowest degree polynomial g(X) in the Galois field GF(q) which fulfills

$$g ( C ) = 0 \qquad ( 19 )$$

where 0 is the zero matrix. The minimum polynomial will divide

$$g ( X ) = {X}^{t} - 1 \qquad ( 20 )$$

in GF(q), from which t can be found. From (18), it follows that:

$${C}^{- 1} = {C}^{t - 1} \qquad ( 21 )$$

Therefore, in an embodiment of the invention, for any matrix C of order t, t−1 sets of orthogonal multiplexing codes can be generated as:

$$\{ C , {C}^{2} , … , {C}^{t - 1} \} \qquad ( 22 )$$

For example, different sets of orthogonal multiplexing codes can be used in different cells of the communication system 500. The exponent k of C^{k} could be a function of the cell identity (ID) and/or could be configured by higher layer signaling.

### Generating Multiplexing Code Matrices

The error probability, Pr[\hat{b}ᵢ≠bᵢ], depends on e and on the ith row of C⁻¹, which can be constructed according to desired properties, as long as the rank of C⁻¹ is equal to N, since that implies that also C has rank equal to N. The best construction of C⁻¹ depends on the assumption of e, i.e., the error model.

Example: Consider binary signaling (q=2) and N=M=3, with two different channels; a binary symmetric channel (BSC) without correlation (BSC ρ=0) and one with full correlation (BSC ρ=1). The latter could occur if the receivers are in close proximity of each other and experience similar propagation channels. For the BSC ρ=0, the errors are independent and are characterized by:

$$\begin{matrix}Pr [ {e}_{i} = 1 ] = {p}_{0} \\ = 1 - Pr [ {e}_{i} = 0 ]\end{matrix} \qquad ( 23 )$$

For the BSC ρ=1, the errors are fully correlated, e₁=e₂=e₃, and are characterized by

$$\begin{matrix}Pr [ e = 1 ] = {p}_{1} \\ = 1 - Pr [ e = 0 ]\end{matrix} \qquad ( 24 )$$

where 0 and 1 are the vectors consisting of zeros and ones, respectively. Furthermore, suppose that

$$C = ( \begin{matrix}1 & 0 & 0 \\ 0 & 1 & 1 \\ 1 & 1 & 0\end{matrix} ) \qquad ( 25 )$$

which has a modular inverse:

$${C}^{- 1} = ( \begin{matrix}1 & 0 & 0 \\ 1 & 0 & 1 \\ 1 & 1 & 1\end{matrix} ) \qquad ( 26 )$$

By using (16) it follows that:

$$( \begin{matrix}{\hat{b}}_{1} \\ {\hat{b}}_{2} \\ {\hat{b}}_{3}\end{matrix} ) = ( \begin{matrix}{b}_{1} \\ {b}_{2} \\ {b}_{3}\end{matrix} ) + ( \begin{matrix}{e}_{1} \\ {e}_{1} + {e}_{3} \\ {e}_{1} + {e}_{2} + {e}_{3}\end{matrix} ) \qquad ( 27 )$$

Then, the error cases can be identified from (27), which are listed in Table 1.

TABLE 1
Example of BSC channels and the corresponding
probabilities for the respective error cases.

| | BSC ρ = 0 | | BSC ρ = 1 | |
|---|---|---|---|---|
| (e₁, e₂, e₃) | Probability | Errors | Probability | Errors |
| (0, 0, 0) | (1 − p₀)³ | None | p₁ | None |
| (0, 0, 1) | (1 − p₀)²p₀ | b₂, b₃ | 0 | None |
| (0, 1, 0) | (1 − p₀)²p₀ | b₃ | 0 | None |
| (0, 1, 1) | (1 − p₀)p₀² | b₂ | 0 | None |
| (1, 0, 0) | (1 − p₀)²p₀ | b₁, b₂, b₃ | 0 | None |
| (1, 0, 1) | (1 − p₀)p₀² | b₁ | 0 | None |
| (1, 1, 0) | (1 − p₀)p₀² | b₁, b₂ | 0 | None |
| (1, 1, 1) | p₀³ | b₁, b₃ | 1 − p₁ | b₁, b₃ |

For the BSC ρ=0, after some simplifications, the following are obtained by inspection in Table 1.

$$P r [ {\hat{b}}_{1} \neq {b}_{1} ] = P r [ {e}_{1} = 1 ] = {p}_{0} \qquad ( 28 )$$

$$Pr [ {\hat{b}}_{2} \neq {b}_{2} ] = P r [ {e}_{1} + {e}_{3} = 1 ] = 2 {p}_{0} ( 1 - {p}_{0} ) \qquad ( 29 )$$

$$Pr [ {\hat{b}}_{3} \neq {b}_{3} ] = P r [ {e}_{1} + {e}_{2} + {e}_{3} = 1 ] = 3 {p}_{0} + 4 {p}_{0}^{3} - 6 {p}_{0}^{2} \qquad ( 30 )$$

and it can be shown (assuming p₀≤0.5) that:

$$P r [ {\hat{b}}_{1} \neq {b}_{1} ] \leq P r [ {\hat{b}}_{2} \neq {b}_{2} ] \leq P r [ {\hat{b}}_{3} \neq {b}_{3} ] \qquad ( 31 )$$

Thus, comparing (31) and (27) it can be concluded that the smaller the Hamming weight of a row in C⁻¹, the smaller the bit error rate (BER) and the smallest BER is for the row having Hamming weight equal to 1. The Hamming weight w(x) of a matrix or vector×is defined as the number of positive elements in x. For the BSC ρ=1, it can be observed that

$$P r [ {\hat{b}}_{2} \neq {b}_{2} ] = 0 \qquad ( 32 )$$

since the second row of C⁻¹ has Hamming weight equal to 2, thus e₁+e₃=0. Based on these observations, the following construction 1 is given.
Construction 1: C is N×N and q=2
   C⁻¹ is a matrix with one element equal to 1, per row, and per column.

For construction 1, it is straightforward to show that the columns of C⁻¹ are orthogonal and they are thus linearly independent. Hence, C⁻¹ has rank equal to N and its inverse is (C⁻¹)⁻¹=C.

Furthermore, the error probability Pr[\hat{b}ᵢ≠bᵢ]=0 for a BSC ρ=1, for a row in C⁻¹ having even Hamming weight, since the sum Σᵢ eᵢ=0 if the number of terms eᵢ is even. Unfortunately, it is not possible to construct C⁻¹ with rank equal to N when every row has even
Construction 2: C is N×N and q=2
   C⁻¹ has rank equal to N and at least one row has even Hamming weight.
      Hamming weight. This leads to construction 2.

However, it is known that the maximum size of a set of binary vectors of length N having a minimum Hamming distance equal to 2, is equal to 2^{N-1}. Hence, it would be possible to find a set of N−1 vectors of Hamming weight equal to 2. For the purpose of constructing C⁻¹, it remains to show that the set can be chosen such that the vectors are linearly independent. A proof by example with N−1 rows having even weight and one row having odd weight is

$${C}^{- 1} = ( \begin{matrix}1 & 1 & 0 & 0 & … & 0 \\ 1 & 0 & 1 & 0 & … & 0 \\ ⋮ & ⋮ & ⋮ & ⋮ & ⋮ & ⋮ \\ 1 & 0 & 0 & 0 & … & 1 \\ 1 & 0 & 0 & 0 & … & 0\end{matrix} ) \qquad ( 33 )$$

where it can be straightforwardly verified that the columns are linearly independent. Thus, the following construction is given.
Construction 3: C is N×N and q=2
   C⁻¹ has rank equal to N and N−1 rows have even Hamming weight.

Furthermore, considering the example in (16) for the BSC ρ=0, it is clear that

$$Pr [ {\hat{b}}_{3} \neq {b}_{3} ] = 0 \qquad ( 34 )$$

if the Hamming weight w(e)=2. Thus, as long as there is an even number of errors, rows in C⁻¹ with odd Hamming weight will be able to provide perfect demultiplexing. Hence, we give the following construction 4.
Construction 4: C is N×N and q=2
   C⁻¹ has rank equal to N and the rows have odd Hamming weight.

An example is where N is even and all rows have Hamming weight w=N−1. For example, for N=4, the rows of

$${C}^{- 1} = ( \begin{matrix}1 & 0 & 1 & 1 \\ 1 & 1 & 0 & 1 \\ 1 & 1 & 1 & 0 \\ 0 & 1 & 1 & 1\end{matrix} ) \qquad ( 35 )$$

are linearly independent and C⁻¹ has rank equal to N.

If the receiver is not able to decide which of the q symbols that was received, the reception diversity could be increased by maximizing the Hamming weight of the rows in C⁻¹, which is given by the following construction 5.
Construction 5. C is N×N and q=2
   C⁻¹ has rank equal to N and a total Hamming weight equal to N²N+1 such that N−1 rows have Hamming weight N−1 and 1 row has Hamming weight N
      An example for N=4 is given by

$${C}^{- 1} = ( \begin{matrix}1 & 1 & 1 & 1 \\ 1 & 1 & 1 & 0 \\ 1 & 1 & 0 & 1 \\ 1 & 0 & 1 & 1\end{matrix} ) \qquad ( 36 )$$

where it can be straightforwardly verified that the rows are linearly independent.

To ensure that the same error probability is experienced for every symbol, the Hamming weight of each row in C⁻¹ would have to be constant. This is obviously true for construction 1, for which the rows have Hamming weight equal to 1. However, it is possible to choose the Hamming weight to be other odd values, which is given by the following
Construction 6: C is N×N and q=2
   C⁻¹ has rank equal to N and every row has the same odd valued Hamming weight
      construction 6.

An example is to let C⁻¹ be a circulant matrix, which is determined as follows:

Let the first row comprise the vector v′₁ having odd Hamming weight w(v′₁).

For 2≤i≤N, let v′ᵢ comprise row i, where v′ᵢ is v′₁ cyclically shifted i−1 steps.

It has been shown that there exists no circulant matrix with rank equal to N and even Hamming weight w(v′₁). Furthermore, it was shown that when N is a power of 2, or when N is a prime with primitive root 2, any vector v′₁ with odd Hamming weight can be used; a prime s with primitive root 2 is such that 2^{s-1}≡1(mod s), which are s∈{3,5,11,13,19,29,37, . . . }. Here, we disclose to let

$${v}_{1}^{′} = [ {\underbrace{1 , 1 , … , 1}}_{w} , {\underbrace{0 , … , 0}}_{N - w} ] \qquad ( 37 )$$

with odd w (w<N), which makes C⁻¹ a Topelitz matrix. An example for N=7 and w=3 is:

$${C}^{- 1} = ( \begin{matrix}1 & 1 & 1 & 0 & 0 & 0 & 0 \\ 0 & 1 & 1 & 1 & 0 & 0 & 0 \\ 0 & 0 & 1 & 1 & 1 & 0 & 0 \\ 0 & 0 & 0 & 1 & 1 & 1 & 0 \\ 0 & 0 & 0 & 0 & 1 & 1 & 1 \\ 1 & 0 & 0 & 0 & 0 & 1 & 1 \\ 1 & 1 & 0 & 0 & 0 & 0 & 1\end{matrix} ) \qquad ( 38 )$$

This form may allow flexibility in the receiver implementation since multiplying r with a Topelitz matrix C⁻¹ can be equivalently expressed as cyclic convolution between r and v₁. Table 2 shows for which cases the parameters N (excluding cases where N is a power of 2, or when N is a prime with primitive root 2) and w result in a Toeplitz C⁻¹ with rank equal to N.

TABLE 2
Cases where Toeplitz C⁻¹ has rank equal to N (labelled Yes)
and where it does not have rank equal to N (labelled No) for the
construction (31), for different length N and Hamming weight w.

w

| N | 3 | 5 | 7 | 9 | 11 | 13 |
|---|---|---|---|---|---|---|
| 6 | No | Yes | — | — | — | — |
| 7 | Yes | Yes | — | — | — | — |
| 9 | No | Yes | Yes | — | — | — |
| 10 | Yes | No | No | Yes | — | — |
| 12 | No | Yes | No | Yes | Yes | |
| 14 | Yes | Yes | No | Yes | Yes | Yes |
| 15 | No | No | Yes | No | Yes | No |

Constructions of Multiplexing Codes when M<N

The set of vectors y in (9) will comprise a linear combination of the columns of C. Therefore, in order to be able to uniquely demultiplex the M symbols bi (1≤i≤M), the rank of C has to be equal to M. Thus, the following condition 2, which is more general than Condition 1, is
Condition 2 If C is an N×M matrix with M×N, it should have rank equal to M over F. adopted.

Let P be an M×M matrix with elements from {0,1, . . . , q−1} having distinct rows and columns, and where every row and every column contains one non-zero element. Furthermore, let A be an (N−M)×M matrix with elements and form the N×M matrix:

$$\tilde{C} = [ \begin{matrix}P \\ A\end{matrix} ] \qquad ( 39 )$$

Due to the properties of P, the columns of \tilde{C} are linearly independent and thus \tilde{C} has rank equal to M. Moreover, any row or column permutation of \tilde{C} will still make \tilde{C} to have

```
Construction 7:
  C is N × M and M < N
  C is obtained from any row or column permutation of
  $\tilde{C} = [ \begin{matrix}P \\ A\end{matrix} ] where P is an M \times M matrix with distinct rows and$
  columns and where every row and every column contains one
  non-zero element, and A is an (N − M) × M matrix.
```

rank equal to M. This is given by the following construction 7.

### Linear Demultiplexing

If M<N, there exists by definition no C⁻¹ but linear demultiplexing could be done according to several embodiments.

Demultiplexing with the Pseudo-Inverse

When considering all real numbers (i.e., when computations are not using the modulo q operator), it can be shown that if C is N×M and has rank equal to M, then the M×M matrix C′C has rank equal to M. However, this property does not hold over when the set of symbols is constrained to {0,1, . . . , q−1}. Therefore, we make the following construction
Construction 8 C is N×M and M<N
   C and C′C have rank equal to M
      8 to achieve this property.

Appendix B contains results for such binary multiplexing codes with respect to Hamming weight and minimum distance. For construction 8, linear demultiplexing can be performed as:

$$\begin{matrix}\hat{b} = {( {C}^{′} C )}^{- 1} {C}^{′} r ( mod q ) \\ = b + {( {C}^{′} C )}^{- 1} {C}^{′} e ( mod q )\end{matrix} \qquad ( 40 )$$

An example of construction 8 for N=7 and M=3 is

$$C = ( \begin{matrix}1 & 1 & 0 \\ 1 & 0 & 0 \\ 1 & 0 & 0 \\ 1 & 0 & 1 \\ 0 & 1 & 1 \\ 0 & 1 & 0 \\ 0 & 1 & 1\end{matrix} ) \qquad ( 41 )$$

for which

$${C}^{′} C = ( \begin{matrix}0 & 1 & 1 \\ 1 & 0 & 0 \\ 1 & 0 & 1\end{matrix} ) ⇔ {( {C}^{′} C )}^{- 1} = ( \begin{matrix}0 & 1 & 0 \\ 1 & 1 & 1 \\ 0 & 1 & 1\end{matrix} ) \qquad ( 42 )$$

are having rank equal to 3.

A further example of construction 8 is where C consists of orthogonal column vectors with odd Hamming weight. In that case, it follows that C′C=I(mod q), which has rank equal to M.

Demultiplexing with Pseudo-Inverse in the Real-Domain and Rounding

In general, the matrix C⁺=(C′C)⁻¹C′ is known as the pseudo-inverse of C and b*=C⁺r is the solution to the least squares problem

$${min}_{b} {‖ Cb - r ‖}_{2} \qquad ( 43 )$$

where ∥.∥₂ is the Euclidean norm. However, if C⁺ is computed modulo q and the symbols are constrained to be in the set {0,1, . . . , q−1}, b* is not the solution to (43). Nevertheless, linear demultiplexing could be performed also for multiplexing codes not necessarily fulfilling construction 8. For example, suppose â and C⁺ are computed in the real domain (i.e., without modulo operation), then an estimate is

$$\hat{a} = {( {C}^{′} C )}^{- 1} {C}^{′} r \qquad ( 44 )$$

$$\hat{b} = round ( \hat{a} , q ) \qquad ( 45 )$$

where the rounding function round(x,q) rounds each element of x to its closest integer in {0,1, . . . , q−1}. The advantage of this is that (44)-(45) works for any C of rank M.

### Generating an Invertible Matrix at the Receiver

Furthermore, a method that works for any C of rank M is that the receiver produces an intermediate inverse as follows:

Append N−M columns to C to create the N×N matrix C_{TX} such that it obtains rank equal to N in F_{q}^{N}.

Determine C71 in F_{q}^{N} and let C_{RX}⁻¹ comprise the first M rows of C_{TX}⁻¹.

Compute \hat{b}=C_{RX}⁻¹r in F_{q}^{N} to demultiplex the M symbols.

Theorem 1 in Appendix A assures that it is possible to append columns to C which are linearly independent.

### Non-Linear Demultiplexing

When M<N, there is redundancy, i.e., more resources are used than the number of multiplexed signals, which can be exploited as a coding gain, e.g., we can rewrite (9) as y′=b′C′ and identify that C′=G is the generator matrix of a linear block code. Thus, any block code with generator matrix G fulfilling condition 2 for C=G′ can be used. Thereto, for any G of a linear block code it can be shown that there exists a parity check matrix H, which has the property that its rows are linearly independent. Thus, it is possible to set C=H′ for any linear block code. As an example, the (N, M, d)=(7,4,3) Hamming code with minimum distance d is generated from

$$G = [ \begin{matrix}1 & 0 & 0 & 0 & 1 & 1 & 0 \\ 0 & 1 & 0 & 0 & 1 & 0 & 1 \\ 0 & 0 & 1 & 0 & 0 & 1 & 1 \\ 0 & 0 & 0 & 1 & 1 & 1 & 1\end{matrix} ] \qquad ( 46 )$$

and has a parity check matrix

$$H = [ \begin{matrix}1 & 1 & 0 & 1 & 1 & 0 & 0 \\ 1 & 0 & 1 & 1 & 0 & 1 & 0 \\ 0 & 1 & 1 & 1 & 0 & 0 & 1\end{matrix} ] \qquad ( 47 )$$

which generates a code with (N, M, d)=(7,3,4). The demultiplexing can be performed by any existing decoding algorithm for block codes, including non-linear algorithms. Notably, for C=G′, it follows that

$${C}^{′} C = [ \begin{matrix}1 & 1 & 1 & 0 \\ 1 & 1 & 1 & 0 \\ 1 & 1 & 1 & 0 \\ 0 & 0 & 0 & 0\end{matrix} ] \qquad ( 48 )$$

which has rank equal to 1, and if C=H′,

$${C}^{′} C = [ \begin{matrix}0 & 0 & 0 \\ 0 & 0 & 0 \\ 0 & 0 & 0\end{matrix} ] \qquad ( 49 )$$

which has rank equal to 0. Therefore, the matrix (C′C)⁻¹C′ does not exist and none of G and H fulfill construction 8.
Non-Binary Multiplexing Codes q>2

Consider the case where q=2^{Q} for some integer Q>1. This implies that the bits in b can be processed in blocks of Q=log₂ q bits. If c is an odd number, then gcd(c, q)=1, where gcd(x, y) is the greatest common divisor of×and y. It implies that there exists a unique inverse c⁻¹ such that cc⁻¹≡1 (mod q). Moreover, this means that for x=0,1, . . . , q−1, the product xc (mod q) produces q distinct values. Hence, additions can be performed modulo q in (9) if c is an odd number. It follows that for a diagonal matrix:

$$C = ( \begin{matrix}{c}_{11} & 0 & 0 & 0 \\ 0 & {c}_{22} & 0 & 0 \\ ⋮ & ⋮ & ⋱ & ⋮ \\ 0 & 0 & 0 & {c}_{NN}\end{matrix} ) ⟺ {C}^{- 1} = ( \begin{matrix}{c}_{11}^{- 1} & 0 & 0 & 0 \\ 0 & {c}_{22}^{- 1} & 0 & 0 \\ ⋮ & ⋮ & ⋱ & ⋮ \\ 0 & 0 & 0 & {c}_{NN}^{- 1}\end{matrix} ) \qquad ( 50 )$$

Thus, any row or column permutation of C in (39) will imply that there exists a

$$\begin{matrix}Construction 9 : C is N \times N and q = {2}^{Q} for some integer Q > 1 \\ \overline{C} = ( \begin{matrix}{c}_{11} & 0 & 0 & 0 \\ 0 & {c}_{22} & 0 & 0 \\ ⋮ & ⋮ & ⋱ & ⋮ \\ 0 & 0 & 0 & {c}_{NN}\end{matrix} ) \\ where {c}_{ii} are odd integers and C is any row or column permuted version of \overline{C} .\end{matrix}$$

modular inverse C⁻¹.
Evaluation Results-Binary Case (q=2)

Consider the following example of multiplexing codes

$$C = ( \begin{matrix}1 & 0 & 0 & 0 \\ 1 & 1 & 0 & 0 \\ 0 & 1 & 1 & 0 \\ 0 & 0 & 1 & 1\end{matrix} ) ⇔ {C}^{- 1} = ( \begin{matrix}1 & 0 & 0 & 0 \\ 1 & 1 & 0 & 0 \\ 1 & 1 & 1 & 0 \\ 1 & 1 & 1 & 1\end{matrix} ) \qquad ( 51 )$$

and using (16), the bit error probabilities are given by:

$$P r [ {\hat{b}}_{1} \neq {b}_{1} ] = P r [ {e}_{1} = 1 ] \qquad ( 52 )$$

$$Pr [ {\hat{b}}_{2} \neq {b}_{2} ] = P r [ {e}_{1} + {e}_{2} = 1 ] \qquad ( 53 )$$

$$Pr [ {\hat{b}}_{3} \neq {b}_{3} ] = P r [ {e}_{1} + {e}_{2} + {e}_{3} = 1 ] \qquad ( 54 )$$

$$Pr [ {\hat{b}}_{4} \neq {b}_{4} ] = P r [ {e}_{1} + {e}_{2} + {e}_{3} + {e}_{4} = 1 ] \qquad ( 55 )$$

Assuming a BSC with error probability p, and computing the probabilities for all error vectors, these error probabilities become as follows:

$$\begin{matrix}Pr [ {\hat{b}}_{1} \neq {b}_{1} , p ] = {p ( 1 - p )}^{3} + 3 {{p}^{2} ( 1 - p )}^{2} + 3 {p}^{3} ( 1 - p ) + {p}^{4} \\ = p\end{matrix} \qquad ( 56 )$$

$$\begin{matrix}Pr [ {\hat{b}}_{2} \neq {b}_{2} , p ] = 2 {p ( 1 - p )}^{3} + 4 {{p}^{2} ( 1 - p )}^{2} + 2 {p}^{3} ( 1 - p ) \\ = 2 p - 2 {p}^{2}\end{matrix} \qquad ( 57 )$$

$$\begin{matrix}Pr [ {\hat{b}}_{3} \neq {b}_{3} , p ] = 3 {p ( 1 - p )}^{3} + 3 {{p}^{2} ( 1 - p )}^{2} + {p}^{3} ( 1 - p ) + {p}^{4} \\ = 3 p - 6 {p}^{2} + 3 {p}^{3}\end{matrix} \qquad ( 58 )$$

$$\begin{matrix}Pr [ {\hat{b}}_{4} \neq {b}_{4} , p ] = 4 {p ( 1 - p )}^{3} + 4 {p}^{3} ( 1 - p ) \\ = 4 p - 12 {p}^{2} + 16 {p}^{3} - 8 {p}^{4}\end{matrix} \qquad ( 59 )$$

The Gilbert-Elliot channel model is assumed in order to capture correlation behavior of the channel, which is a 2-state Markov model. A BSC with error probability p_{g} is used in the Good state (G) and a BSC with error probability p_{b} is used in the Bad state (B). The transition probability from G to B, is set to P_{gb}=0.1 and the transition probability from B to G, is set to p_{bg}=0.3. The steady state probabilities can be determined as

$${π}_{G} = \frac{{p}_{b g}}{{p}_{b g} + {p}_{g b}} \qquad ( 60 )$$

$$and$$

$${π}_{B} = \frac{{p}_{g b}}{{p}_{b g} + {p}_{g b}} \qquad ( 61 )$$

implying that the average bit error probability for bit i becomes

$${P}_{i} = P r [ {\hat{b}}_{i} \neq {b}_{i} , {p}_{g} ] {π}_{G} + P r [ {\hat{b}}_{i} \neq {b}_{i} , {p}_{b} ] {π}_{B} \qquad ( 62 )$$

and the expressions (56)-(59) are inserted in (62). The (7,4,3) Hamming code of (46) is also evaluated. The bit error probability using maximum likelihood (ML) detection on a BSC exists on closed-form and has been shown to be given by

$$P r [ {\hat{b}}_{i} \neq {b}_{i} , p ] = \frac{1}{N} {\sum }_{i = 0}^{N} {iA}_{i} P ( p , i ) \qquad ( 63 )$$

where the Hamming weight distribution of the codewords is

$${A}_{0} = 1 , {A}_{3} = 7 , {A}_{4} = 7 , {A}_{7} = 1 \qquad ( 64 )$$

and has been derived as

$$P ( p , i ) = i {{p}^{i - 1} ( 1 - p )}^{N - i + 1} + {{p}^{i} ( 1 - p )}^{N - i} + ( N - i ) {{p}^{i + 1} ( 1 - p )}^{N - i - 1} \qquad ( 65 )$$

which can be combined and inserted in to (62). ML detection minimizes the codeword error probability but not necessarily the BER, for which maximum aposteriori (MAP) decoding algorithms have to be used.

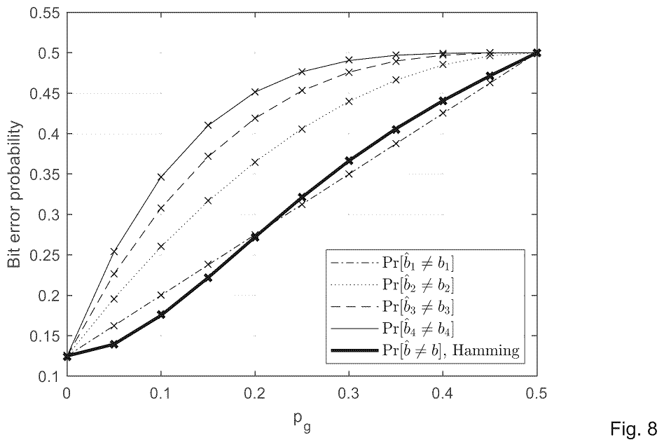

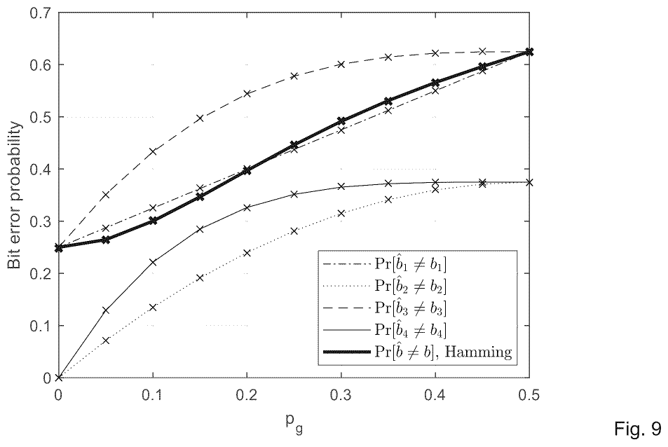

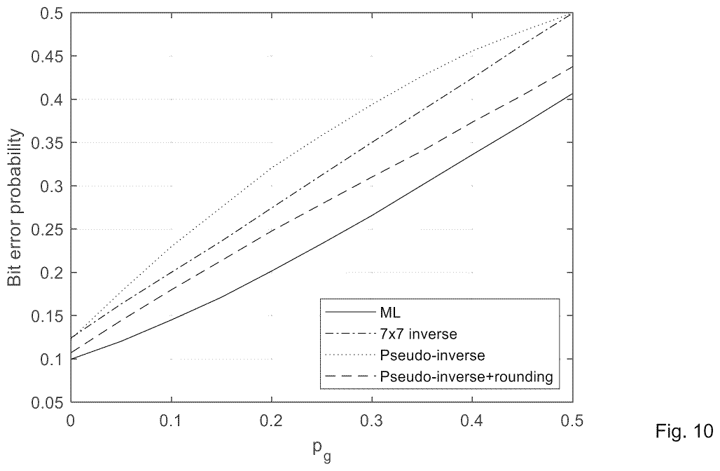

In FIG. 8, the bit error probabilities are plotted as function of p_{g} for p_{b}=0.5. Monte-Carlo simulations are also performed (results marked with ‘x’), which are in perfect alignment with the derived expressions. From (52)-(55), it can be understood that the bit error probability increases with the Hamming weight of the rows of C⁻¹, i.e., Pr[\hat{b}₁≠b₁]≤Pr[\hat{b}₂≠b₂]≤Pr[\hat{b}₃≠b₃]≤Pr[\hat{b}₄≠b₄]. The figures also include the results of the Hamming code, showing that the coding gain result in the lowest BER, up to p_{g}≈0.2. The cost of this is the use of 7 resources for multiplexing 4 signals. With larger p_{b}, FIG. 9 shows that the multiplexing codes resulting in rows of C⁻¹ with even Hamming weight (i.e., row 2 and 4), become relatively better at higher pb, and may even outperform the Hamming code. Also, it is possible that the BER becomes larger than 0.5.

To evaluate the different demultiplexing algorithms, the following matrix is used for N=7 and M×4

$$C = ( \begin{matrix}1 & 0 & 0 & 0 \\ 0 & 1 & 0 & 0 \\ 0 & 0 & 1 & 0 \\ 0 & 0 & 0 & 1 \\ 0 & 1 & 1 & 0 \\ 0 & 0 & 0 & 0 \\ 0 & 0 & 0 & 0\end{matrix} ) \qquad ( 66 )$$

which results in the pseudo-inverse:

$${( {C}^{′} C )}^{- 1} {C}^{′} ( mod q ) = ( \begin{matrix}1 & 0 & 0 & 0 & 0 & 0 & 0 \\ 0 & 0 & 1 & 0 & 1 & 0 & 0 \\ 0 & 1 & 0 & 0 & 1 & 0 & 0 \\ 0 & 0 & 0 & 1 & 0 & 0 & 0\end{matrix} ) \qquad ( 67 )$$

For the method of generating an invertible matrix at the receiver, 4 columns are added to C such that it has rank equal to 7.

$$\tilde{C} = ( \begin{matrix}1 & 0 & 0 & 0 & 0 & 0 & 0 \\ 0 & 1 & 0 & 0 & 0 & 0 & 0 \\ 0 & 0 & 1 & 0 & 0 & 0 & 0 \\ 0 & 0 & 0 & 1 & 0 & 0 & 0 \\ 0 & 1 & 1 & 0 & 1 & 0 & 0 \\ 0 & 0 & 0 & 0 & 0 & 1 & 0 \\ 0 & 0 & 0 & 0 & 0 & 0 & 1\end{matrix} ) ⟹ {C}_{RX}^{- 1} = ( \begin{matrix}1 & 0 & 0 & 0 & 0 & 0 & 0 \\ 0 & 1 & 0 & 0 & 0 & 0 & 0 \\ 0 & 0 & 1 & 0 & 0 & 0 & 0 \\ 0 & 0 & 0 & 1 & 0 & 0 & 0\end{matrix} ) \qquad ( 68 )$$

Since (67) has 2 rows with Hamming weight equal to 2, the BER will be larger than for (68) since all rows have Hamming weight equal to 1, which can be confirmed from FIG. 9, which compares the average BER of the different demultiplexing algorithms; ML on (66), matrix inverse (68), pseudo-inverse (67) computed over the set of symbols {0,1, . . . , q−1} and the pseudo-inverse with rounding to integers. The ML clearly performs better than the others.

Bit Labels-Non-Binary Case q>2

Consider the case of Q>1 and process Q=log₂ q bits from each user, which are arranged in a vector as

$$b = {( {b}_{11} , {b}_{12} , … , {b}_{1 Q} , {b}_{21} , {b}_{22} , … , {b}_{2 Q} , … , {b}_{U 1} , {b}_{U 2} , … , {b}_{U Q} )}^{′} \qquad ( 69 )$$

where M=UQ and

$${b}_{i j} , 1 \leq i \leq U , 1 \leq j \leq Q \qquad ( 70 )$$

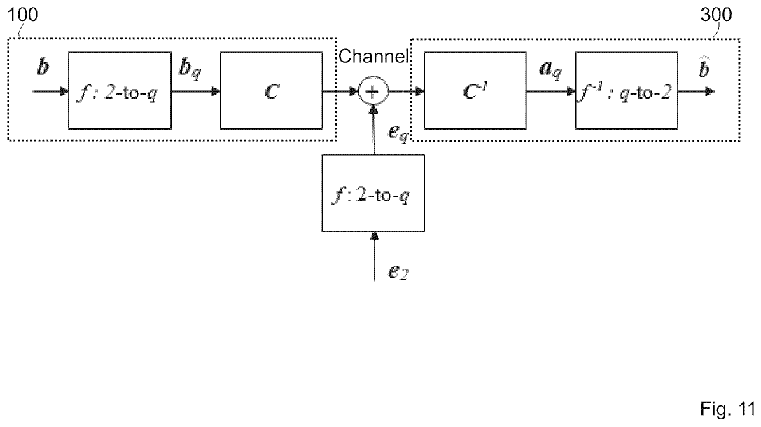

denotes the jth bit of user i. The q=2^{Q} symbols could be signaled by one transmission of a q-ary waveform (e.g., q-FSK or OOK with q pulses). Alternatively, the q symbols could be signaled by Q transmissions of a binary waveform (e.g., 2-FSK, or OOK with 2 pulses). Let the function f map a block of Q bits to a label L∈{0,1, . . . , q−1}, and the inverse function f⁻¹ provide the bit representation from the label. Furthermore, the binary error vector e₂ of length M is mapped to the q-ary error vector e_{q} of length U, as shown in the transmitter-receiver chain of FIG. 11 involving the first communication device 100 and the second communication device 300. In FIG. 11, the binary vector b is transformed to the q-ary vector b_{q}. Multiplexing and de-multiplexing is made by q-ary matrices C and C⁻¹, respectively. The entries in vector bg could indicate which of the q signals that is designated for a receiver.

Errors occur when

$${f}^{- 1} ( {b}_{q} + {C}^{- 1} {e}_{q} ) \neq b \qquad ( 71 )$$

and the function f is crucial which affects the BER as shown by the following example.

Example: Let M=N=4, q=16 and the following:

$$C = ( \begin{matrix}3 & 0 & 0 & 0 \\ 0 & 5 & 0 & 0 \\ 0 & 0 & 7 & 0 \\ 0 & 0 & 0 & 9\end{matrix} ) ⇔ {C}^{- 1} = ( \begin{matrix}11 & 0 & 0 & 0 \\ 0 & 3 & 0 & 0 \\ 0 & 0 & 7 & 0 \\ 0 & 0 & 0 & 9\end{matrix} ) \qquad ( 72 )$$

We will determine the error probability for bits (b₃₁, b₃₂, b₃₃, b₃₄) and will thus need to utilize the third row of C⁻¹ and multiply the third element of e_{q} with c₃₃⁻¹=7. Suppose a BSC and a mapping defined as in Table 3, where e_{q}=f(e₂), and the corresponding probabilities of the error vector.

TABLE 3
Example of the function ƒ and corresponding probabilities.

| e₂ | Pr[e₂] | ƒ(e₂) | C₃₃⁻¹e_{q} | ƒ⁻¹(c₃₃⁻¹e_{q}) |
|---|---|---|---|---|
| (0, 0, 0, 0) | (1 − p)⁴ | 0 | 0 | (0, 0, 0, 0) |
| (0, 0, 0, 1) | p(1 − p)³ | 6 | 10 | (0, 1, 1, 0) |
| (0, 0, 1, 0) | p(1 − p)³ | 2 | 14 | (0, 1, 0, 0) |
| (0, 0, 1, 1) | p²(1 − p)² | 3 | 5 | (1, 1, 1, 0) |
| (0, 1, 0, 0) | p(1 − p)³ | 14 | 2 | (0, 0, 1, 0) |
| (0, 1, 0, 1) | p²(1 − p)² | 1 | 7 | (0, 1, 1, 1) |
| (0, 1, 1, 0) | p²(1 − p)² | 10 | 6 | (0, 0, 0, 1) |
| (0, 1, 1, 1) | p³(1 − p) | 7 | 1 | (0, 1, 0, 1) |
| (1, 0, 0, 0) | p(1 − p)³ | 8 | 8 | (1, 0, 0, 0) |
| (1, 0, 0, 1) | p²(1 − p)² | 5 | 3 | (0, 0, 1, 1) |
| (1, 0, 1, 0) | p²(1 − p)² | 4 | 12 | (1, 1, 0, 0) |
| (1, 0, 1, 1) | p³(1 − p) | 11 | 13 | (1, 1, 0, 1) |
| (1, 1, 0, 0) | p²(1 − p)² | 12 | 4 | (1, 0, 1, 0) |
| (1, 1, 0, 1) | p³(1 − p) | 13 | 11 | (1, 0, 1, 1) |
| (1, 1, 1, 0) | p³(1 − p) | 9 | 15 | (1, 1, 1, 1) |
| (1, 1, 1, 1) | p⁴ | 15 | 9 | (1, 0, 0, 1) |

Consider the special case where b_{q}=0, i.e., (b₃₁, b₃₂, b₃₃, b₃₄)=(0,0,0,0), then (71) simplifies and

$${( {\hat{b}}_{31} , {\hat{b}}_{32} , {\hat{b}}_{33} , {\hat{b}}_{34} )}^{′} = {f}^{- 1} ( {c}_{33}^{- 1} {e}_{q} ) \qquad ( 73 )$$

and the error probability is

$${P}_{i} = Pr [ {\hat{b}}_{3 i} \neq 0 ] \qquad ( 74 )$$

and using Table 3, we can identify that:

$${P}_{1} = Pr [ {e}_{q} = 3 , 4 , 8 , 9 , 11 , 12 , 13 , 15 ] = {p ( 1 - p )}^{3} + 3 {{p}^{2} ( 1 - p )}^{2} + 3 {p}^{3} ( 1 - p ) + {p}^{4} \qquad ( 75 )$$

$${P}_{2} = Pr [ {e}_{q} = 1 , 2 , 3 , 4 , 6 , 7 , 9 , 11 ] = 2 {p ( 1 - p )}^{3} + 3 {{p}^{2} ( 1 - p )}^{2} + 3 {p}^{3} ( 1 - p ) \qquad ( 76 )$$

$${P}_{3} = Pr [ {e}_{q} = 1 , 3 , 5 , 6 , 9 , 12 , 13 , 14 ] = 2 {p ( 1 - p )}^{3} + 4 {{p}^{2} ( 1 - p )}^{2} + 2 {p}^{3} ( 1 - p ) \qquad ( 77 )$$

$${P}_{4} = Pr [ {e}_{q} = 1 , 5 , 7 , 9 , 10 , 11 , 13 , 15 ] = 3 {p}^{2} ( 1 - {p}^{2} ) + 4 {p}^{3} ( 1 - p ) + {p}^{4} \qquad ( 78 )$$

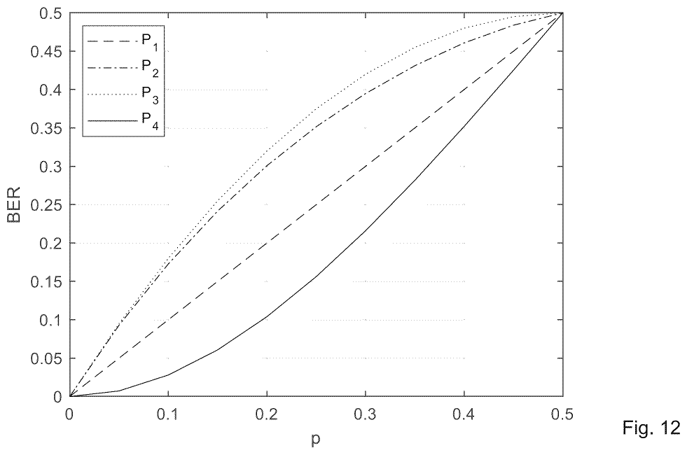

These are plotted in FIG. 12, where it is noted that P₄<p, i.e., it is possible to achieve a lower bit error rate than given by the BSC channel, even without utilizing any coding gain since N=M.

The optimized bit label mapping is compared with the natural mapping and the Gray mapping, according to Table 4.

TABLE 4
Mapping of bit labels to integers for
optimized, natural and Gray mapping.

| Bit | | | |
|---|---|---|---|
| label | Optimized | Natural | Gray |
| (0, 0, 0, 0) | 0 | 0 | 0 |
| (0, 0, 0, 1) | 6 | 1 | 1 |
| (0, 0, 1, 0) | 2 | 2 | 3 |
| (0, 0, 1, 1) | 3 | 3 | 2 |
| (0, 1, 0, 0) | 14 | 4 | 7 |
| (0, 1, 0, 1) | 1 | 5 | 6 |
| (0, 1, 1, 0) | 10 | 6 | 4 |
| (0, 1, 1, 1) | 7 | 7 | 5 |
| (1, 0, 0, 0) | 8 | 8 | 15 |
| (1, 0, 0, 1) | 5 | 9 | 14 |
| (1, 0, 1, 0) | 4 | 10 | 12 |
| (1, 0, 1, 1) | 11 | 11 | 13 |
| (1, 1, 0, 0) | 12 | 12 | 8 |
| (1, 1, 0, 1) | 13 | 13 | 9 |
| (1, 1, 1, 0) | 9 | 14 | 11 |
| (1, 1, 1, 1) | 15 | 15 | 10 |

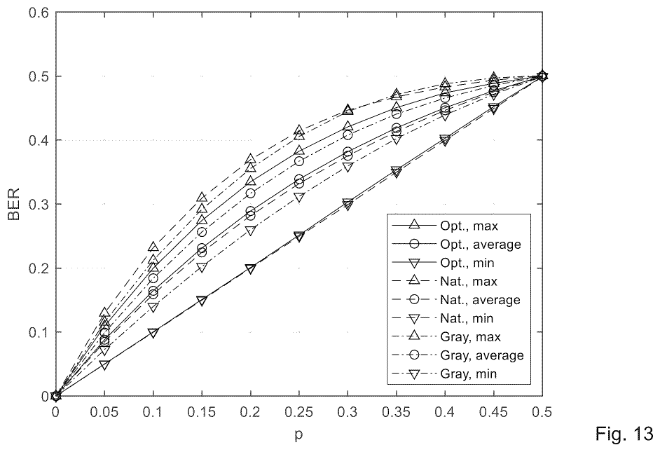

For the results of FIG. 13, the vectors b_{q} are generated randomly over GF(q) and the plot contains the minimum

$$BER {min}_{i = 1 , ... , 16} {P}_{i} ;$$

the maximum

$$BER {max}_{i = 1 , ... , 16} {P}_{i} ;$$

and the average

$$BER \frac{1}{16} {\sum }_{i = 1}^{16} {P}_{i} .$$

It can be seen that the Gray mapping is not having any significant performance gain, while the optimized mapping provides the lowest maximum error probability of all mappings.

From Table 3, it can be observed that vectors

$${f}^{- 1} ( {c}_{33}^{- 1} {e}_{q} )$$

with large Hamming weight affect more bits. The optimized bit label assignment is therefore to let states with large Hamming weight get labels such that the corresponding probability becomes small. For example,

$${f}^{- 1} ( {c}_{33}^{- 1} {e}_{q} ) = ( 1 , 1 , 1 , 1 )$$

associated with the probability for state 9, i.e., p³(1−p). Assume that C is a diagonal matrix, then the procedure can be summarized with the following steps:
1. Select an index i∈{1, . . . , M}.
2. Let X be a state which has not been assigned a label, and which has a Hamming weight being not smaller than that of any remaining un-assigned state.
3. Assign a label to state X∈{0,1, . . . , q−1}.
4. Determine the corresponding label Y=cᵢᵢ⁻¹ X(mod q) and assign Y to an unassigned state with the largest possible Hamming weight.
5. If there are unassigned states, return to step 2.

This implies that the difference in Hamming weight of the bit labels for state X and Y=cᵢᵢ⁻¹ X(mod q), is at most 1.
Construction 10 For C according to construction 9, each symbol from {0,1 . . . q−1} is associated with a bit label such that the difference in Hamming weight between bit labels for symbol X and Y=cᵢᵢ⁻¹ X(mod q) is at most 1.

### Parameter Selection

If the disclosed solution is applied to a 3GPP NR system with the WUS mechanism, the number of time-frequency resources, N, should preferably fit into the existing time-and frequency domain structure of the system. For example, if the WUS waveform is FSK, the subcarriers of the OFDM waveform could serve as the frequencies. A resource block comprises 12 subcarriers and it would thus be efficient if N=12k, k=1,2, . . . , i.e., it is a multiple of 12.

If the WUS waveform is OOK, one OFDM symbol could serve as the time-domain resource of an OOK symbol. The NR time-domain structure includes slots, whose length depends on the subcarrier spacing, and each slot contains 14 OFDM symbols. Hence, it would be efficient if N=14k, k=1,2, . . . , i.e., it is a multiple of 14.

For the case where N>M, the matrix C could be constructed from the generator matrix or parity check matrix of a suitable block code of length N. One example is the binary Golay code with parameters (N, M, d)=(24,12,8). Another example is a Hadamard code with N=12k, which is a non-linear code consisting of 2N codewords and minimum distance d=N/2. Thus, M = [log2 2N] WUSs could be multiplexed with such a code, where └.┘ is the floor operator. Several operations are possible on a (N, M) code to achieve the desired length, i.e., rate matching:
Puncturing: By deleting p coded bits, an (N, M) code becomes a (N−p, M) code.
Shortening: By deleting p message bits, an (N, M) code becomes a (N−p, M−p) code.
Extending: By adding additional p redundant bits, an (N, M) code becomes a (N+p, M) code.
Lengthening: By adding additional p message bits, an (N, M) code becomes a (N+p, M+p) code.

In particular 3GPP NR contains polar code and Reed-Muller code, which are linear block codes that could be used to produce C.

A network access node herein may also be denoted as a radio network access node, an access network access node, an access point (AP), or a base station (BS), e.g., a radio base station (RBS), which in some networks may be referred to as transmitter, “gNB”, “gNodeB”, “eNB”, “eNodeB”, “NodeB” or “B node”, depending on the standard, technology and terminology used. The radio network access node may be of different classes or types such as e.g., macro eNodeB, home eNodeB or pico base station, based on transmission power and thereby the cell size. The radio network access node may further be a station, which is any device that contains an IEEE 802.11-conformant media access control (MAC) and physical layer (PHY) interface to the wireless medium (WM). The radio network access node may be configured for communication in 3GPP related long term evolution (LTE), LTE-advanced, fifth generation (5G) wireless systems, such as new radio (NR) and their evolutions, as well as in IEEE related Wi-Fi, worldwide interoperability for microwave access (WiMAX) and their evolutions.

A client device herein may be denoted as a user device, a user equipment (UE), a mobile station, an internet of things (IoT) device, a sensor device, a wireless terminal and/or a mobile terminal, and is enabled to communicate wirelessly in a wireless communication system, sometimes also referred to as a cellular radio system. The UEs may further be referred to as mobile telephones, cellular telephones, computer tablets or laptops with wireless capability. The UEs in this context may be, for example, portable, pocket-storable, hand-held, computer-comprised, or vehicle-mounted mobile devices, enabled to communicate voice and/or data, via a radio access network (RAN), with another communication entity, such as another receiver or a server. The UE may further be a station, which is any device that contains an IEEE 802.11-conformant MAC and PHY interface to the WM. The UE may be configured for communication in 3GPP related LTE, LTE-advanced, 5G wireless systems, such as NR, and their evolutions, as well as in IEEE related Wi-Fi, WiMAX and their evolutions.

Furthermore, any method according to embodiments of the invention may be implemented in a computer program, having code means, which when run by processing means causes the processing means to execute the steps of the method. The computer program is included in a computer readable medium of a computer program product. The computer readable medium may comprise essentially any memory, such as previously mentioned a ROM, a PROM, an EPROM, a flash memory, an EEPROM, or a hard disk drive.

Moreover, it should be realized that the first communication device 100 and the second communication device 300 comprise the necessary communication capabilities in the form of e.g., functions, means, units, elements, etc., for performing or implementing embodiments of the invention. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, TCM encoder, TCM decoder, power supply units, power feeders, communication interfaces, communication protocols, etc. which are suitably arranged together for performing the solution.

Therefore, the processor(s) of the first communication device 100 and the second communication device 300 may comprise, e.g., one or more instances of a CPU, a processing unit, a processing circuit, a processor, an ASIC, a microprocessor, or other processing logic that may interpret and execute instructions. The expression “processor” may thus represent a processing circuitry comprising a plurality of processing circuits, such as e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the invention is not limited to the embodiments described above, but also relates to and incorporates all embodiments within the scope of the appended independent claims.

### Appendix A

Condition 1 makes it necessary to find a set of linearly independent vectors in F^{N}(q). For the binary case, the following theorem, which is proven in Appendix A, gives a sufficient condition for the size of a candidate set from which the vectors are chosen. Thus, it is described how to generate a set of linearly independent binary vectors.

Theorem 1. Define a candidate set S of arbitrary but distinct N-dimensional vectors over F^{N}(2), where the set size is |S|≥2^{N-1}, then it is possible to select N linearly independent vectors from S.

The theorem describes a sufficient condition, since if S is not arbitrary it could be possible to find a set of linearly independent vectors, even when |S|<2^{N-1}. For example, if the candidate set consists of the N unit vectors, which are orthogonal, they are also linearly independent.

Proof of Theorem 1. Define the empty set Q₀=ø, the candidate set S₀ and proceed according to the following steps.
Step 1. Take a vector v₁∈S₀ and define the sets Q₁=Q₀∪v₁ and S₁=S₀\v₁. Thus, |Q₁|=1 and |S₁|=|S₀|=1.
Step 2. Take a vector v₂∈S₁ and define the sets Q₂=Q₁Åv₂ and S₂=S₁\v₂. Furthermore, if v₁+v₂∈S₁, then S₁=S₀\(v₁+v₂). Thus, |Q₂|=2 and |S₂|≥|S₁|−1−1=|S₀|−3.
Step 3. Take a vector v₃∈S₂ and define the sets Q₃=Q₂Åv₂ and S₃=S₂\v₃. Furthermore:

$$If {v}_{3} + {v}_{1} ∈ {S}_{2} , then {S}_{2} = {S}_{2} \text{\textbackslash (} {v}_{3} + {v}_{1} ) .$$

$$If {v}_{3} + {v}_{2} ∈ {S}_{2} , then {S}_{2} = {S}_{2} \text{\textbackslash (} {v}_{3} + {v}_{2} ) .$$

$$If {v}_{3} + {v}_{1} + {v}_{2} ∈ {S}_{2} , then {S}_{2} = {S}_{2} \text{\textbackslash (} {v}_{3} + {v}_{1} + {v}_{2} ) .$$

$$Thus , \vert {Q}_{3} \vert = 3 and \vert {S}_{3} \vert \geq \vert {S}_{2} \vert - 1 - 3 = \vert {S}_{0} \vert - 7.$$

$$…$$

Step p. Take a vector vₚ∈Sₚ₋₁ and define the sets Qₚ=Qₚ₋₁∪vₚ and Sₚ=Sₚ₋₁\vₚ.

Furthermore, for every linear combination \tilde{v}_{α}=Σᵢ₌₁^{p-1}αᵢvᵢ+vₚ, where αᵢ∈GF(2), if \tilde{v}_{α}∈Sₚ₋₁ then Sₚ=Sₚ₋₁\\tilde{v}_{α}.

Thus,

$$\vert {Q}_{p} \vert = p and \vert {S}_{p} \vert \geq \vert {S}_{p - 1} \vert - 1 - ( \begin{matrix}p - 1 \\ 1\end{matrix} ) - ( \begin{matrix}p - 1 \\ 2\end{matrix} ) - … - ( \begin{matrix}p - 1 \\ p - 1\end{matrix} ) = \vert {S}_{p - 1} \vert - {2}^{p - 1} .$$

By recursion, |Sₚ|≥|S₀|−Σⱼ₌₀^{p-1}2^{j}=|S₀|+1−2^{p}. For p=N−1, we require that |S_{N-1}|≥1, which implies that |S₀|≥^{N-1}.

### Appendix B

Table 5 contains the minimum Hamming distance, dₘᵢₙ, of all the codewords of the multiplexing code generated by C of size N×M and the Hamming weight, w, of (C′C)⁻¹C′. The matrices C have been obtained by exhaustive search. A large dₘᵢₙ is beneficial for a non-linear demultiplexing algorithm while small w is beneficial for a linear demultiplexing algorithm.

TABLE 5
Minimum Hamming distance dmin for multiplexing codes generated
from C and Hamming weight w of (C′C)⁻¹C′.

| | N = 5 | | | N = 6 | | | N = 7 | | |
|---|---|---|---|---|---|---|---|---|---|
| | M = 2 | M = 3 | M = 4 | M = 2 | M =3 | M = 4 | M = 2 | M = 3 | M = 4 |
| dₘᵢₙ | 2 | 2 | 2 | 3 | 2 | 2 | 4 | 3 | 2 |
| w | 4 | 11 | 16 | 6 | 11 | 16 | 8 | 13 | 16 |

1. A first communication device for a communication system, the first communication device comprising:
one or more processors in communications with a non-transitory memory storing computer instructions, wherein the instructions, when executed by the one or more processors, cause the apparatus to:
obtain a vector b comprising M number of integer valued information symbols from a set {0, 1, . . . , q−1}, where q=2^{Q} and where Q is a positive integer;
obtain a N×M matrix C comprising symbols from the set {0, 1, . . . , q−1}, where N is a positive integer such that M≤N;
multiply the matrix C with the vector b modulo-q to obtain a vector y comprising N number of transmission symbols, wherein each transmission symbol in the vector y is associated with one of q number of signals; and
transmit an associated signal for each transmission symbol in the vector y to one or more receivers.

2. The first communication device according to claim 1, wherein a component k with 1≤k≤N in the vector y is associated with time/frequency resource k.

3. The first communication device according to claim 1, wherein N=12n or N=14n for any positive integer value of n.

4. The first communication device according to claim 1, wherein the vector b comprises information symbols for different receivers.

5. The first communication device according to claim 4, wherein the vector b comprises Sᵤ number of information symbols for receiver u such that
$${\sum }_{u = 1}^{U} {S}_{u} = M$$
where U is the number of receivers with 1≤U≤M.

6. The first communication device according to claim 1, wherein the associated signal is any one of:
an on-off keying signal;
a frequency shift keying signal;
an orthogonal frequency division multiplex signal; or a discrete Fourier transform precoded orthogonal frequency division multiplex signal.

7. The first communication device according to claim 1, wherein at least one information symbol represents any one of:
an indicator to wake-up a receiver or a group of receivers;
an identity of a receiver or a group of receivers; or
a paging information associated with a receiver or a group of receivers.

8. The first communication device according to claim 1, wherein M=N, and wherein C and C⁻¹ comprise integer valued symbols from the set {0, 1, . . . , q−1} and fulfil
$${C}^{- 1} C = I ( mod q ) ,$$
where C⁻¹ is the modular inverse of C, I is the identity matrix and mod q is the modulo-q operator.

9. The first communication device according to claim 1, wherein C is a N×N matrix and has a rank equal to N, where q=2, and wherein C⁻¹ fulfills at least one of:
C⁻¹ is a matrix with one element equal to 1 per row and per column;
C⁻¹ is a matrix where at least one row has an even Hamming weight;
C⁻¹ is a matrix where N−1 number of rows have an even Hamming weight;
C⁻¹ is a matrix where the rows have an odd Hamming weight;
C⁻¹ is a matrix with a total Hamming weight equal to N²−N+1 such that N−1 number of rows have a Hamming weight equal to N−1 and 1 row has a Hamming weight equal to N; and/or
C⁻¹ is a matrix where every row has the same odd-valued Hamming weight.

10. The first communication device according to claim 1, wherein C is a N×N matrix and has rank equal to N, where Q>1, and wherein C is any row or column permuted version of a matrix C̅ given as
$$\overline{C} = ( \begin{matrix}{c}_{11} & 0 & 0 & 0 \\ 0 & {c}_{22} & 0 & 0 \\ ⋮ & ⋮ & ⋱ & ⋮ \\ 0 & 0 & 0 & {c}_{NN}\end{matrix} )$$
where cᵢᵢ are odd integers from the set {0, 1, . . . , q−1}, and where for at least one i with 1≤i≤N, each symbol in the set {0, 1, . . . , q−1} is associated with a bit label such that a difference in Hamming weight between bit labels for symbol X and Y=cᵢᵢ⁻¹ X(mod q) is at most 1.

11. The first communication device according to claim 1, wherein M=N, wherein t is the smallest positive integer such that Ct=I(mod q), and wherein up to t−1 matrices are generated for the communication system as:
{C, C², . . . , C^{t-1}}.

12. The first communication device according to claim 1, wherein C is a N×M matrix and has a rank equal to M, where M<N and q=2,and wherein C fulfills at least one of:
C is obtained from any row or column permutation of a matrix \tilde{C} given as
$$\tilde{C} = [ \begin{matrix}P \\ A\end{matrix} ]$$
where P is an M×M matrix with distinct rows and columns and where every row and every column contains one non-zero element, and where A is an (N−M)×M matrix;
a product of C′C has a rank equal to M where C′ is the transpose of C; and/or C comprises orthogonal column vectors with an odd Hamming weight.

13. A second communication device for a communication system, the second communication device comprising:
one or more processors in communications with a non-transitory memory storing computer instructions, wherein the instructions, when executed by the one or more processors, cause the apparatus to:
receive N number of signals, wherein each signal is associated with a symbol from a set {0, 1, . . . , q−1}, where q=2^{Q} and where Q is a positive integer;
determine M number of integer valued information symbols from N number of associated symbols based on a N×M matrix C or its modular inverse, where the matrix C and its modular inverse comprises symbols from the set {0, 1, . . . , q−1}, where N is a positive integer such that M≤N.

14. The second communication device according to claim 13, wherein a signal is any one of:
an on-off keying signal;
a frequency shift keying signal;
an orthogonal frequency division multiplex signal; or
a discrete Fourier transform precoded orthogonal frequency division multiplex signal.

15. The second communication device according to claim 13, wherein at least one information symbol represents any one of:
an indicator to wake-up a receiver or a group of receivers;
an identity of a receiver or a group of receivers; or
a paging information associated with a receiver or a group of receivers.

16. The second communication device according to claim 13, wherein M=N, and wherein C and C⁻¹ comprise integer valued symbols from the set {0, 1, . . . , q−1} and fulfil
$${C}^{- 1} C = I ( mod q ) ,$$
where C⁻¹ is the modular inverse of C, I is the identity matrix and mod q is the modulo-q operator.

17. The second communication device according to claim 13, wherein C is a N×N matrix and has a rank equal to N, where q=2, and wherein C⁻¹ fulfills at least one of:
C⁻¹ is a matrix with one element equal to 1 per row and per column;
C⁻¹ is a matrix where at least one row has an even Hamming weight;
C⁻¹ is a matrix where N−1 number of rows have an even Hamming weight;
C⁻¹ is a matrix where the rows have an odd Hamming weight;
C⁻¹ is a matrix with a total Hamming weight equal to N²−N+1 such that N−1 number of rows have a Hamming weight equal to N−1 and 1 row has a Hamming weight equal to N; and/or
C⁻¹ is a matrix where every row has the same odd-valued Hamming weight.

18. The second communication device according to claim 13, wherein C is a N×N matrix and has rank equal to N, where Q>1, and wherein C is any row or column permuted version of a matrix C̅ given as
$$\overline{C} = ( \begin{matrix}{c}_{11} & 0 & 0 & 0 \\ 0 & {c}_{22} & 0 & 0 \\ ⋮ & ⋮ & ⋱ & ⋮ \\ 0 & 0 & 0 & {c}_{NN}\end{matrix} )$$
where cᵢᵢ are odd integers from the set {0, 1, . . . , q−1}, and where for at least one i with 1≤i≤N, each symbol in the set {0, 1, . . . , q−1} is associated with a bit label such that a difference in Hamming weight between bit labels for symbol X and Y=cᵢᵢ⁻¹ X(mod q) is at most 1.

19. The second communication device according to claim 13, wherein C is a N×M matrix and has a rank equal to M, where M<N and q=2, and wherein C fulfills at least one of:
C is obtained from any row or column permutation of a matrix \tilde{C} given as
$$\tilde{C} = [ \begin{matrix}P \\ A\end{matrix} ]$$
where P is an M×M matrix with distinct rows and columns and where every row and every column contains one non-zero element, and where A is an (N−M)×M matrix;
a product of C′C has a rank equal to M where C′ is the transpose of C; and/or
C comprises orthogonal column vectors with an odd Hamming weight.

20. A method for a first communication device, the method comprising:
obtaining a vector b comprising M number of integer valued information symbols from a set {0, 1, . . . , q−1}, where q=2^{Q} and where Q is a positive integer;
obtaining a N×M matrix C comprising symbols from the set {0, 1, . . . , q−1}, where N is a positive integer such that M≤N;
multiplying the matrix C with the vector b modulo-q to obtain a vector y comprising N number of transmission symbols, wherein each transmission symbol in the vector y is associated with one of q number of signals; and
transmitting an associated signal for each transmission symbol in the vector y to one or more receivers.
